(19) United States
(12) Patent Application Publication
(10) Pub. No.: US 2013/0198013 A1
(43) Pub. Date: Aug. 1, 2013

(54) CONSUMER-INITIATED PAYMENT TO SKIP ELECTRONIC ADVERTISEMENTS

(71) Applicants: Michael D. Shehan, Niwot, CO (US); J. Allen Dove, Boulder, CO (US); Steven B. Swoboda, Denver, CO (US)

(72) Inventors: Michael D. Shehan, Niwot, CO (US); J. Allen Dove, Boulder, CO (US); Steven B. Swoboda, Denver, CO (US)

(73) Assignee: SPOTXCHANGE, INC. A Delaware Corporation

(21) Appl. No.: 13/436,584

(22) Filed: Mar. 30, 2012

Related U.S. Application Data
(60) Provisional application No. 61/591,268, filed on Jan. 26, 2012.

(51) Int. Cl. G06Q 30/02

(52) U.S. Cl. 705/14.73

(57) ABSTRACT

Systems and methods for an electronic brokerage allowing consumer-initiated payment to skip electronic advertisements at publisher electronic content interfaces are provided. According to one embodiment, an electronic brokerage is designed to allow paid, consumer-initiated advertisement skipping, which involves providing secured electronic client code and processes that are placed on publisher electronic content interfaces that execute within consumer browsers to allow consumers to choose whether they wish to pay to skip specific electronic advertising opportunities. Electronic brokerage systems and processes allow publishers and consumers to securely register accounts with the brokerage that are used, respectively, to provide non-repudiated electronic advertising opportunity attestation and explicit consent/dissent to pay to skip those advertising opportunities. Furthermore, electronic mechanism are also provided by the brokerage to allow consumers to fund their brokerage accounts monetarily and, optionally, by accruing vouchers to allow skipping of electronic advertisements in exchange for participation in brokerage-sponsored activities.

### CROSS-REFERENCE TO RELATED APPLICATIONS

This application claims the benefit of U.S. Provisional Application No. 61/591,268 filed on Jan. 26, 2012, which is hereby incorporated by reference in its entirety for all purposes.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright© 2012, SpotXchange, Inc.

### BACKGROUND

1. Field

Embodiments of the present invention generally relate to the field of electronic advertising. In particular, embodiments of the present invention relate to the brokering of consumer-initiated payments to skip electronic advertisements and the systems and methods required to provide such.

2. Description of the Related Art

The Internet has become an increasingly attractive medium for advertisers of information, products and services to reach consumers. The growth of online video has likewise accelerated.

The features of video, audio and animation that online video offers are attractive to advertisers because these features support objectives such as awareness and message association. Many names have been used to describe the TV-like “video ad” units that have been inserted before, during or after online video, including: in-stream commercials, in-video commercials, streaming commercials, video commercials, multimedia adjacencies, and many others. So as to have a standard term for these ad units, the Interactive Advertising Bureau (IAB) has recommended using the name “broadband video commercial” to refer to these units.

As broadband video commercials have become ubiquitous, consumers of online video content, some of whom expected to escape TV-like advertising by going online, are desirous of skipping broadband video commercials. This consumer demand has resulted in the availability of browser plug-ins, such as Adblock Plus, that purport to remove advertisements from web pages. Such an approach is short-sighted in that publishers (e.g., web sites) which depend on advertising income to disseminate content may be unable to continue. Another potential disadvantage of an ad blocking approach is that it may block too much and prevent some web sites from functioning correctly.

### SUMMARY

Systems and methods are described for an electronic brokerage allowing consumer-initiated payment to skip electronic advertisements at publisher electronic content interfaces. According to one embodiment, an electronic brokerage is provided that allows participating publishers, which make available advertising-supported content, to offer consumers an option to skip electronic advertisements associated with the advertising-supported content for a fee.

Other features of embodiments of the present invention will be apparent from the accompanying drawings and from the detailed description that follows.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a simplified context level diagram illustrating interactions among external actors and an electronic brokerage system in accordance with an embodiment of the present invention.

FIG. 2 is a high-level diagram that conceptually illustrates logical components that provide the electronic brokerage system architecture in accordance with an embodiment of the present invention.

FIG. 3 is a flowchart illustrating opportunity attestation processing in accordance with an embodiment of the present invention.

FIG. 4 is a flowchart illustrating opportunity handling processing in accordance with an embodiment of the present invention.

FIG. 5 is a flowchart illustrating funding check processing in accordance with an embodiment of the present invention.

FIG. 6 is a flowchart illustrating opportunity consent processing in accordance with an embodiment of the present invention.

FIG. 7 is a flowchart illustrating opportunity dissent processing in accordance with an embodiment of the present invention.

FIG. 8 is a flowchart illustrating consumer login processing in accordance with an embodiment of the present invention.

FIG. 9 is a flowchart illustrating consumer registration processing in accordance with an embodiment of the present invention.

FIG. 10 is an example of a computer system with which embodiments of the present invention may be utilized.

FIG. 11 is a high-level diagram that conceptually illustrates the integration of a publisher electronic interface with a brokerage skip operating system (SkipOS) and interactions between them and a consumer in accordance with an embodiment of the present invention.

FIG. 12 is a high-level diagram that conceptually illustrates the integration of a publisher electronic interface with a brokerage skip operating system (SkipOS) and interactions between them and a consumer in accordance with an alternative embodiment of the present invention.

FIG. 13A is a screenshot of an electronic advertisement having overlaid thereon a brokerage invite explaining the brokerage offering to the consumer and providing mechanisms for the consumer to either register with the brokerage or log into their existing account according to one embodiment of the present invention.

FIG. 13B is a screenshot of an electronic advertisement having overlaid thereon a brokerage invite walking a consumer through registering an account with a brokerage according to one embodiment of the present invention.

FIG. 13C is a screenshot of a an electronic advertisement having overlaid thereon a brokerage invite prompting a consumer to log into an existing account, allowing for third party authentication mechanisms according to one embodiment of the present invention.

FIG. 13D is a screenshot of an electronic advertisement having overlaid thereon a brokerage invite offering a consumer the opportunity to skip an electronic advertisement according to one embodiment of the present invention.

FIG. 13E is a screenshot of an electronic advertisement having overlaid thereon a brokerage invite displaying account information to a consumer according to one embodiment of the present invention.

FIG. 13F is a screenshot of an electronic advertisement having overlaid thereon a brokerage growler informing a consumer that they just successfully paid for skipping the electronic advertisement according to one embodiment of the present invention.

### DETAILED DESCRIPTION

Methods and systems are described for an electronic ad skipping service that provides consumers with the ability to pay (e.g., pennies at a time) to skip content associated with electronic advertisements. According to one embodiment, the ad skipping service provides an electronic brokerage that allows publishers to offer consumers an option to skip electronic advertisements for a fee, thereby maintaining revenue flow to publishers regardless of whether they play an ad to a particular consumer. Typically, the ad skipping service would be integrated with a video advertising system, such as that described in co-pending and commonly owned U.S. patent application Ser. No. 12/117,726, which is hereby incorporated by reference in its entirety for all purposes.

Depending upon the particular implementation, publishers may present an ad skipping widget linearly or non-linearly to consumers during ad presentation. In one embodiment, if the consumer already has an account with an ad skipping service that is separate and independent from the publisher, then the consumer may be provided an opportunity to securely login to their account via the widget (and the login may optionally be persisted for future ads). In one embodiment, once logged in, if the consumer's ad skipping service account is sufficiently funded, the widget will prompt the consumer for explicit consent to skip the ad at issue. If consent is provided, the ad will not be presented and the consumer is able to move directly to the desired content. If not, then the ad will be presented normally by the publisher. In contrast to subscription content services (“pay walls”), embodiments of the present invention are intended for use when content is accessible only if paid for by a consumer or supported by advertising revenue.

In some embodiments, auto-skip functionality may be provided. For example, if the consumer already has an account with the ad skipping service, is persistently logged in and has previously configured their account for auto-skip and the publisher placement meets the consumer's skip criteria, then advertising content may be automatically skipped and appropriate funds or skip credits are automatically deducted from the consumer's account.

In embodiments of the present invention, the electronic brokerage may provide publishers with a secured electronic client to use on their channel electronic user interfaces to securely broker skip opportunities with consumers. This client minimally provides electronic mechanisms for: (i) consumers to securely register an account with the brokerage; (ii) consumers to securely authenticate themselves against a brokerage account; (iii) publishers to securely attest non-repudiated skip opportunities via their brokerage seat; and (iv) consumers to securely authorize non-repudiated electronic skip consents/dissents via their brokerage account during their interactions with a channel's electronic interface. The client may also make available other brokerage account facilities to the consumer. In some embodiments, the electronic brokerage tracks and provides insights into electronic advertising market statistical indicators across publishers and consumers.

In the following description, numerous specific details are set forth in order to provide a thorough understanding of embodiments of the present invention. It will be apparent, however, to one skilled in the art that embodiments of the present invention may be practiced without some of these specific details. In other instances, well-known structures and devices are shown in block diagram form.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware and/or by human operators.

Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present invention may also be downloaded as one or more computer program products, wherein the program may be transferred from a remote computer to a requesting computer by way of data signals embodied in a carrier wave or other propagation medium via a communication link (e.g., a modem or network connection).

In various embodiments, the article(s) of manufacture (e.g., the computer program products) containing the computer programming code may be used by executing the code directly from the machine-readable storage medium or by copying the code from the machine-readable storage medium into another machine-readable storage medium (e.g., a hard disk, RAM, etc.) or by transmitting the code on a network for remote execution. Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

For sake of illustration and simplicity, embodiments of the present invention are described with reference to the payment of US currency to skip electronic advertising; however, it is to be understood that the present invention is not limited to a particular currency and is applicable to the electronic exchange of any type of legal tender for skipping of electronic advertisements.

Notably, while embodiments of the present invention may be described using modular programming terminology, the code implementing various embodiments of the present invention is not so limited. For example, the code may reflect other programming paradigms and/or styles, including, but not limited to object-oriented programming (OOP), agent oriented programming, aspect-oriented programming, attribute-oriented programming (@OP), automatic programming, dataflow programming, declarative programming, functional programming, event-driven programming, feature oriented programming, imperative programming, semantic-oriented programming, functional programming, genetic programming, logic programming, pattern matching programming and the like.

### Terminology

Brief definitions of terms used throughout this application are given below.

The term “account”, “brokerage account” and the like generally refers to the brokerage's persistent, non-repudiated, electronic representation of consumer, including their authentication data and the monetary instruments specifically allocated to their account for skipping electronic advertisements. A brokerage account formally authorizes a consumer to pay to skip electronic advertising opportunities on publisher channels.

The term “advertiser” generally refers to a person, company, firm, entity or agent that is interested in running an electronic advertisement on a publisher channel.

The term “attest” or “attested”, “opportunity attestation” and the like generally refers to a publisher offering an electronic advertisement opportunity for paid skipping to a consumer by making a non-repudiated electronic request to the brokerage.

The phrase “attested opportunity”, “opportunity”, “skip opportunity” and the like generally refers to an individual electronic advertising opportunity at a publisher channel that the publisher has electronically attested with the brokerage as being available for skipping by a consumer for a fee.

The term “brokerage” generally refers to computing infrastructure, software and electronic services provided by embodiments of the present invention. In one embodiment, an electronic brokerage system operates as a brokerage for buying and selling advertising skips. For example, the electronic brokerage system may sell advertising skips (or monetary credits usable toward skips) to consumers desiring to skip video advertisements and allow partner publishers to “buy” the advertising skips from the consumers in exchange for not playing an ad before, during or after an online video.

The term “browser” generally refers to an application, program, process or device used by a consumer in a client/server relationship that requests information or services from a publisher program, process or device (a server) on a network. The term “browser” also encompasses software that makes the connection between a requesting application, program, process or device to a server possible, such as a Hypertext Transport Protocol (HTTP) client.

The term “channel” generally refers to an organization and categorization of electronic content provided by a publisher as a source of advertising inventory.

The phrase “client”, “brokerage client” and the like generally refers to the electronic interface provided by the brokerage for use on publisher electronic user interfaces to securely broker skip opportunities with consumers.

The term “consumer” generally refers to an individual human that generates advertising inventory by way of interactions with publisher electronic interfaces.

The term “content” generally refers to information in the form of one or more or a combination of text, audio, still images, animation, video or interactivity content forms, including, but not limited to broadband video commercials (e.g., TV-like video ad units inserted before, during or after online video, including in-stream commercials, in-video commercials, streaming commercials, video commercials, multimedia adjacencies, in-game commercials, in-service advertising and the like, as well as in-page video ad placements).

The phrase “cost per impression”, “opportunity cost” and the like generally refers to the monetary value assigned a particular electronic advertising opportunity by a publisher and represents the fee a consumer would need to pay to skip that opportunity.

The term “CPI” is an acronym for cost per impression.

The term “CPM” is an acronym for cost per thousand impressions.

The term “durability” generally refers to an algorithm applied by the brokerage during the receipt and processing of electronic opportunity attestations and their correlated electronic skip consents/dissents that determines whether or not consumer charges and publisher credits for an opportunity should be made pending, confirmed or reversed.

The phrases “in one embodiment,” “according to one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment.

The term “invite”, the phrase “brokerage invite” and the like generally refer to the visual “call to action” presented electronically to a consumer on a channel interface brokering electronic advertising opportunities for paid skipping.

The term “linear” generally refers to an electronic advertising opportunity that takes over the electronic content experience on a channel for a period of time.

If the specification states a component or feature “may”, “can”, “could”, or “might” be included or have a characteristic, that particular component or feature is not required to be included or have the characteristic.

The term “non-linear” generally refers to an electronic advertising opportunity that runs concurrently with the electronic content experience on a channel.

The phrase “opportunity GUID” generally refers to the globally unique identifier assigned by the brokerage to every attested opportunity.

The phrase “opportunity receipt” generally refers to the optional electronic confirmation sent by the brokerage to a publisher for each attested opportunity.

The phrase “opportunity receipt callback” generally refers to the optional electronic callback provided the brokerage by a publisher to use to provide opportunity receipts. This callback may be associated and registered with the publisher's brokerage account or may be provided as part of each opportunity attestation. An example of one such embodiment is an HTTP secure (HTTPS) Universal Resource Locator (URL).

The term “publisher” generally refers to a person, company, firm, entity or agent that owns content or the rights to content, is providing consumers electronic access to this content, is registered and integrated with the brokerage, and is interested in receiving compensation, typically monetarily, for access to this content by providing advertising inventory in relation to such content.

The term “seat”, “brokerage seat” and the like generally refers to the brokerage's persistent, non-repudiated, electronic representation of a publisher, including their authentication data, the channels specifically defined by and assigned to the publisher within the brokerage and the fees collected for skip opportunities offered to consumers. A brokerage seat formally authorizes the publisher to offer consumers electronic advertising opportunities for paid skipping through the brokerage.

The phrase “skip consent” generally refers to the secure electronic callback made by the brokerage client on behalf of a consumer that provides non-repudiated consent by the consumer to pay to skip an electronic advertising opportunity.

The phrase “skip dissent” generally refers to the secure electronic callback made by the brokerage client on behalf of a consumer that provides non-repudiated dissent by the consumer not to pay to skip an electronic advertising opportunity and instead view/interact with the advertisement.

The phrase “skip operating system” or “SkipOS” generally refers to code embedded within partner publishers' web sites that allow skipping of electronic advertisements. According to one embodiment, when a consumer interacts with a partner publisher's electronic interface, the SkipOS interacts with the consumer by running on the consumer's browser and communicates with the brokerage on behalf of the publisher via an application programming interface (API) implemented within publisher facilities of the ad skipping service.

that runs on client browsers and/or partner publisher's web sites to allow skipping of electronic advertisements.

The term “voucher” generally refers to a brokerage-backed monetary instrument assigned to a consumer by the brokerage. According to one embodiment vouchers may be assigned to a consumer in exchange for participation in sponsored activities or in response to consumer-initiated skip consent disputes. Each voucher can be used towards consumer paying to skip electronic advertising opportunities.

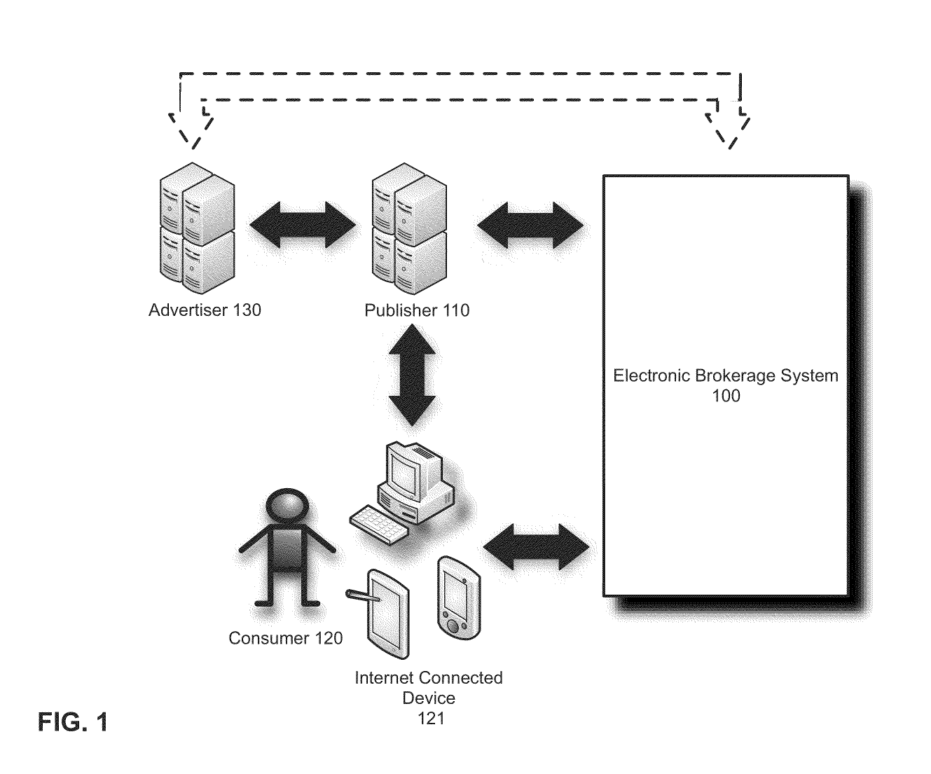

FIG. 1 is a simplified context level diagram illustrating interactions among external actors and an electronic brokerage system 100 in accordance with an embodiment of the present invention. For purposes of brevity only a single publisher 110, consumer 120 and advertiser 130 are illustrated. It is to be understood that multiple publishers, consumers and advertisers would interact with electronic brokerage system 100 in a typical commercial environment.

In the context of the present simplified example, electronic brokerage system 100 is shown having communication interfaces (through the Internet, for example) with publisher 110 and consumer 120 and includes an optional communication interface with advertiser 130. In embodiments in which electronic brokerage system 100 also serves as a video advertising system in which advertisers may bid for placement, such as the video advertising system described in U.S. patent application Ser. No. 12/117,726 (previously incorporated by reference), advertiser 130 would be provided with a direct interface to electronic brokerage system 100; however, this advertiser interface is optional in other contexts.

According to the present example, an ad skipping service may be provided by electronic brokerage system 100, which allows publishers, such as publisher 110, to offer consumers, such as consumer 120, an option to skip electronic advertisements for a fee.

In general, from the perspective of consumer 120, when a video ad plays on a publisher's site that is a partner of the ad skipping service, the ad skipping service causes an invite to be displayed (e.g., in the top left corner of the ad) asking if consumer 120 would like to skip the ad. As described in further detail below, if consumer 120 is a registered customer of the ad skipping service and is logged in, consumer 120 can skip the ad by simply clicking the invite. According to one embodiment, if consumer 120 is not a registered customer of the ad skipping service or not currently logged in, clicking on the invite pauses the ad and the invite expands to allow consumer 120 to sign up or sign in directly with the ad skipping service or by using social network authentication (e.g., the consumer's Facebook, Twitter or Google account).

In one embodiment, the ad skipping service provides consumer 120 with choice and control, ease of use and a better online experience. The ad skipping service allows consumer 120 to control his/her online ad experience by skipping video ads when desired, for a small fee per skip. The ad skipping service is simple and easy to use. With a single click on the invite overlaid on the video ad, consumer 120 (if registered and logged in) can choose to skip the video ad. Meanwhile, non-members can quickly create an account with the ad skipping service using social network authentication or by creating an account directly on a web site associated with the ad skipping service. As a result of not forcing consumer 120 to view ads to support the production, licensing and distribution of content, the ad skipping service provides consumer 120 with a better online experience. If consumer 120 wants to skip a particular video ad, he/she can. And, if consumer 120 wants to watch it, he/she can.

As described below, in embodiments of the present invention, in order to skip video ads, consumer 120 must have an account (e.g., a secure digital wallet) with the ad skipping service with a minimum level of funding (e.g., five dollars). The ad skipping service may accept multiple forms of payment to fund the account, such as electronic transfer (e.g., automated clearing house (ACH) transfer or wire transfer) from a designated bank account, credit card (e.g., Visa, MasterCard, Discover, American Express), online wallet (e.g., PayPal, Amazon Payments and Google Checkout) and/or mobile payment. Consumer 120 may fund his/her secure digital wallet manually or by setting up auto-funding when the account falls below the minimum level of funding. Consumer 120 may be offered incentives to earn free skips. Free skips may be earned by consumer 120 for certain service milestones, e.g., signing up for an account, funding his/her account (e.g., one free skip for each dollar deposited over a minimum threshold), referrals and the like.

In one embodiment, the ad skipping service may recognize consumer 120 the same way other web services do, through the use of an anonymous cookie stored on the consumer's Internet connected device 121 (e.g., a desktop or laptop computer, a tablet computer or a smartphone). Consumer 120 can ensure he/she stays logged in to the ad skipping service by enabling cookies within their web browser (e.g., Safari, Chrome, Internet Explorer, Firefox and the like).

In general, from the perspective of publisher 110, the ad skipping service allows publisher 110 to provide a better consumer experience by enabling visitors to skip online video ads. With abandonment rates on pre-roll ads as high as nearly 40%, some consumers are already making the choice to leave sites that show pre-roll ads. By creating a better consumer experience that lowers abandonment rates, the ad skipping service allows publisher 110 to increase their available video ad inventory. The ad skipping service also allows publisher 110 to make more money by paying publisher 110 high CPMs for skipped ads. The ad skipping service may also enhance relationships between publisher 110 and advertisers, such as advertiser 130, as advertisers are credited for skipped ads, thereby eliminating wasteful ad spending. In addition, by offering consumers a choice, publisher 110 is offering a more engaging ad placement to advertisers, which increases the quality and relevancy of publisher's ad inventory.

In one embodiment, publisher 110 and the ad skipping service agree upon a fee (e.g., $0.10) for each ad that is skipped on the web site of publisher 110. The ad skipping service tracks which ads are skipped and then pays publisher 110 on a periodic basis (e.g., a monthly basis) for those skipped ads. According to one embodiment, even if consumer 120 skips an ad using a free credit, publisher 110 is still paid.

Various tools can be used by publisher 110 to credit its advertisers. In one embodiment, publisher 110 is provided with access to a dashboard within the ad skipping service, which, among other things, allows publisher 110 to download a comprehensive report on all ads that were skipped within a selectable date period. This allows publisher 110 to determine how much publisher 110 will be paid by the ad skipping service and how much of that among will need to be credited to advertisers. As described further below, another tool that can be used by publisher 110 is a skip operating system (not shown), which can be integrated within any partner publisher's web site to allow for reporting of skipped ads via a real-time beacon, for example. In one embodiment, this beacon can be fired to as many destinations as desired. The beacon may be fired at the moment the consumer chooses to skip the ad. Publisher 110 can choose to file the beacon back to the advertiser from which they received the ad. For any type of advertiser crediting tool, it is helpful to have the ad providers include one of more of the following attributes when returning a call from publisher 110 that just requested an ad:
Foreign ID
VAST URL (no path)
VAST Ad ID
VAST AdTitle
VAST MediaFile URL (no path)

Use of the above-listed attributes and the like allow publisher 110 to log actionable data that can be shared with the advertiser that served the ad and make it each for publisher 110 to report and credit its advertisers for their skipped ads as well as their ad serving costs.

Additionally, publisher 110 can fire a skipped ad beacon via the skip operating system integrated within its web site to the advertiser or the ad net so they can keep track of their skipped ads.

Advertisers, such as advertiser 130, may benefit from use of the ad skipping service by publisher 110 because it eliminates wasted impressions, provides consumer insight and helps achieve greater brand engagement. Since advertiser 130 receives credits for skipped ads, advertiser 130 can eliminate waste. Advertiser 130 effectively increases the efficiency and impact of advertising spending by not paying for ads served to consumers who don't want to see the ads (and are therefore not the target audience of the ads). Advertiser 130 is also able to receive information regarding the demographics of consumers that skipped or did not skip its ads, which ultimately helps advertiser 130 better target their audience and tailor the most relevant video ads to those most likely to watch them. Finally, advertiser 130 can achieve greater brand engagement when consumers choose to watch their ads instead of skipping them. For example, if the ad skipping service eliminates the 16% to 37% of video ads that are abandoned (and therefore were never clicked on or completed), the performance of those video ads that are watched is likely to increase.

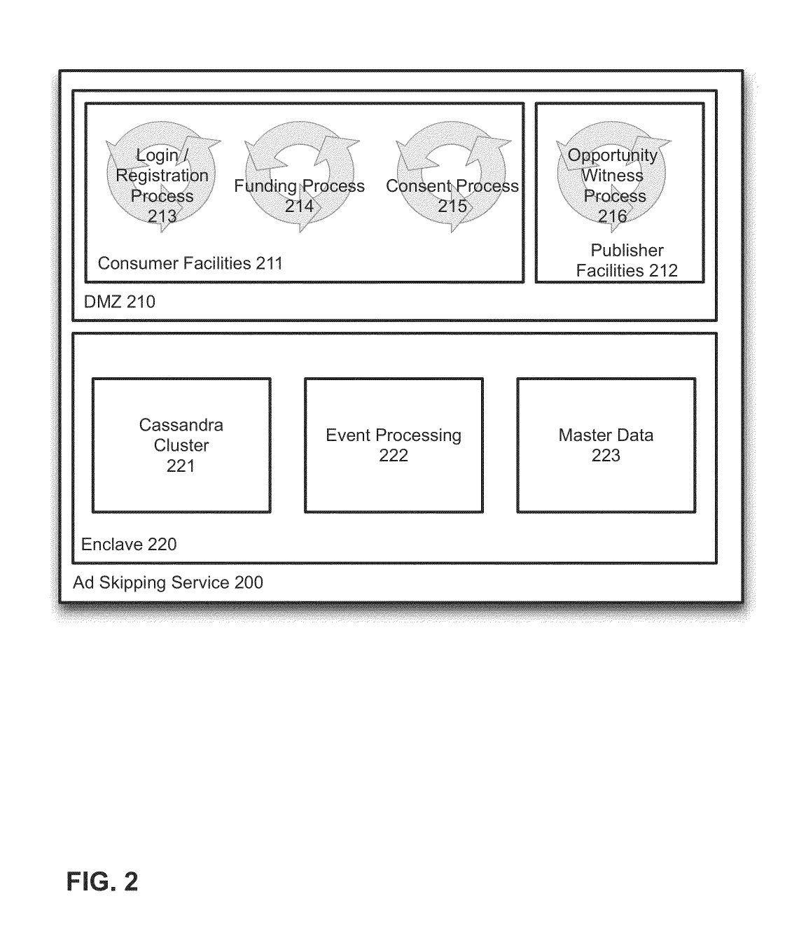

FIG. 2 is a high-level diagram that conceptually illustrates logical components that provide the electronic brokerage system architecture in accordance with an embodiment of the present invention. According to the present example, an ad skipping service 200 operates as an electronic brokerage that allows publishers to offer consumers an option to skip electronic advertisements for a fee.

In the present example, ad skipping service 200 is divided into a publically accessible “demilitarized” zone (DMZ) 210 and a non-publically accessible enclave 220. DMZ 210 provides consumer facilities 211 and publisher facilities 212.

Consumer facilities 211 are accessible by prospective registered consumers and registered consumers for login, registration and funding of consumer accounts and processing of skip consents/dissents initiated by consumers having an account with ad skipping service 200. According to one embodiment, consumer facilities 211 are accessible via a consumer portal or via channel interaction by a consumer during interaction with a channel electronic interface. For example, login or registration may be performed as a result of a consumer's interactions with a brokerage invite or as a result of a consumer interacting directly with the consumer portal hosted by a domain associated with the ad skipping service 200, for example.

Publisher facilities 212 provide an opportunity witness process 216 that interfaces via API interaction with a SkipOS (not shown) implemented within a partner publisher's web site. According to one embodiment, publisher facilities 212 may also provide a publisher portal accessible via a domain associated with the ad skipping service 200, for example.

According to the present example, enclave 220 includes a Cassandra cluster 221, an event processing module 222 and a master data unit 223. Cassandra cluster 221 responds to real-time seat and account inquiries made by opportunity witness process 216. In one embodiment, Cassandra cluster 221 leverages Memcache, Apache Cassandra or other fast, key-value stores for making the real-time seat and account inquiries. Those skilled in the art will appreciate various other fast, key-value stores may be utilized. Event processing module 222 may provide scoring and registration batch processing for processing opportunity events and opportunity datum associated with skip chains. In one embodiment, skip chain datum are stored and “swept” for later processing and registration in data warehouses via scoring and registration batch processors operable within event processing module 222. Master data unit 223 maintains transactional data (e.g., financial, account and transactions) and data warehouses (e.g., a publisher database, a placement database, a financial database, an opportunity database and a performance/statistics database).

In one embodiment, the functionality of one or more of the above-referenced functional units may be merged in various combinations. Moreover, the various functional units can be communicatively coupled using any suitable communication method (e.g., message passing, parameter passing, and/or signals through one or more communication paths, etc.). Additionally, the functional units can be physically connected according to any suitable interconnection architecture (e.g., fully connected, hypercube, etc.).

According to embodiments of the invention, the functional units can be any suitable type of logic (e.g., digital logic, software code and the like) for executing the operations described herein. Any of the functional units used in conjunction with embodiments of the invention can include machine-readable media including instructions for performing operations described herein. Machine-readable media include any mechanism that provides (i.e., stores and/or transmits) information in a form readable by a machine (e.g., a computer). For example, a machine-readable medium includes read only memory (ROM), random access memory (RAM), magnetic disk storage media, optical storage media or flash memory devices.

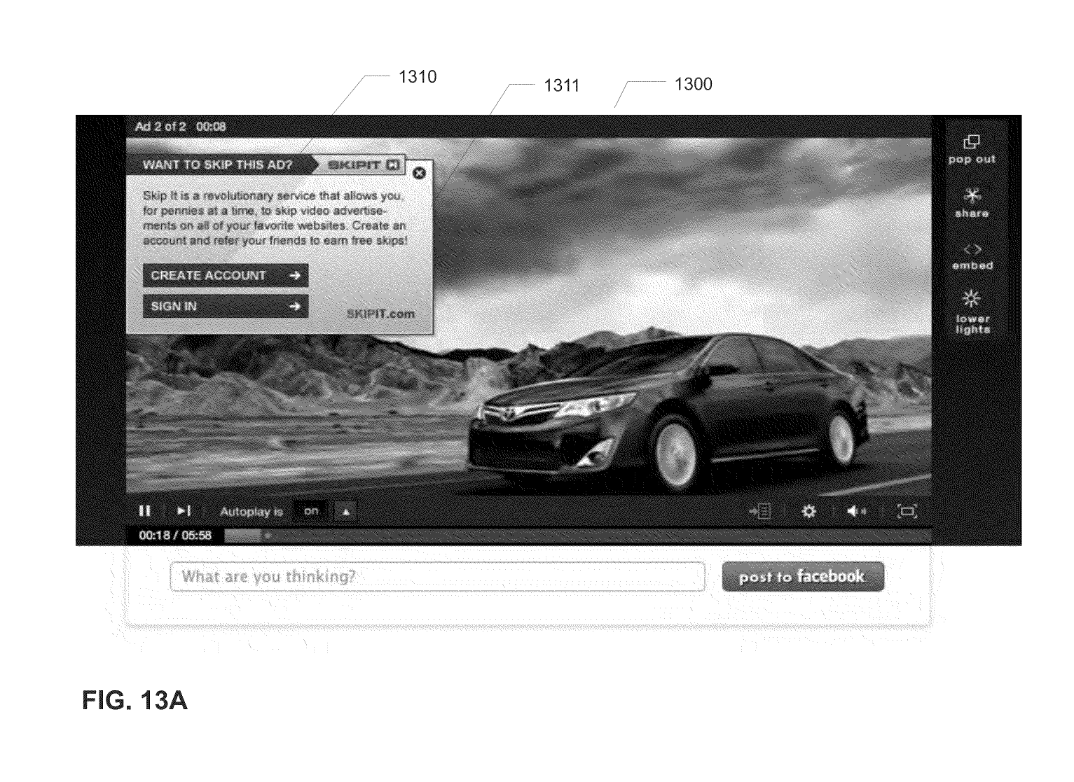

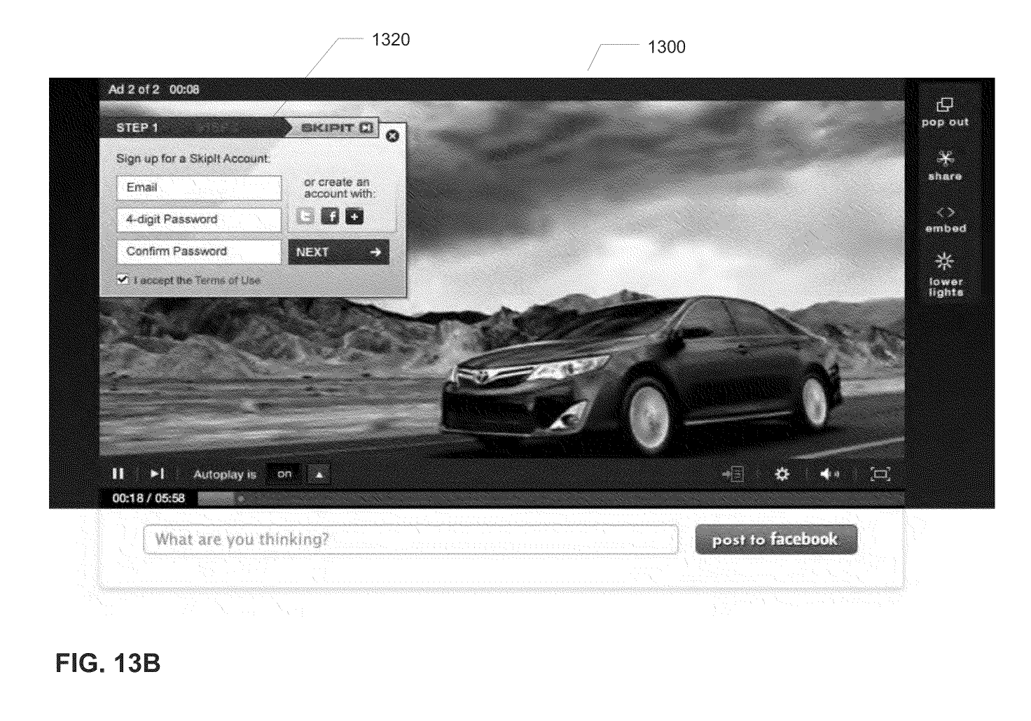

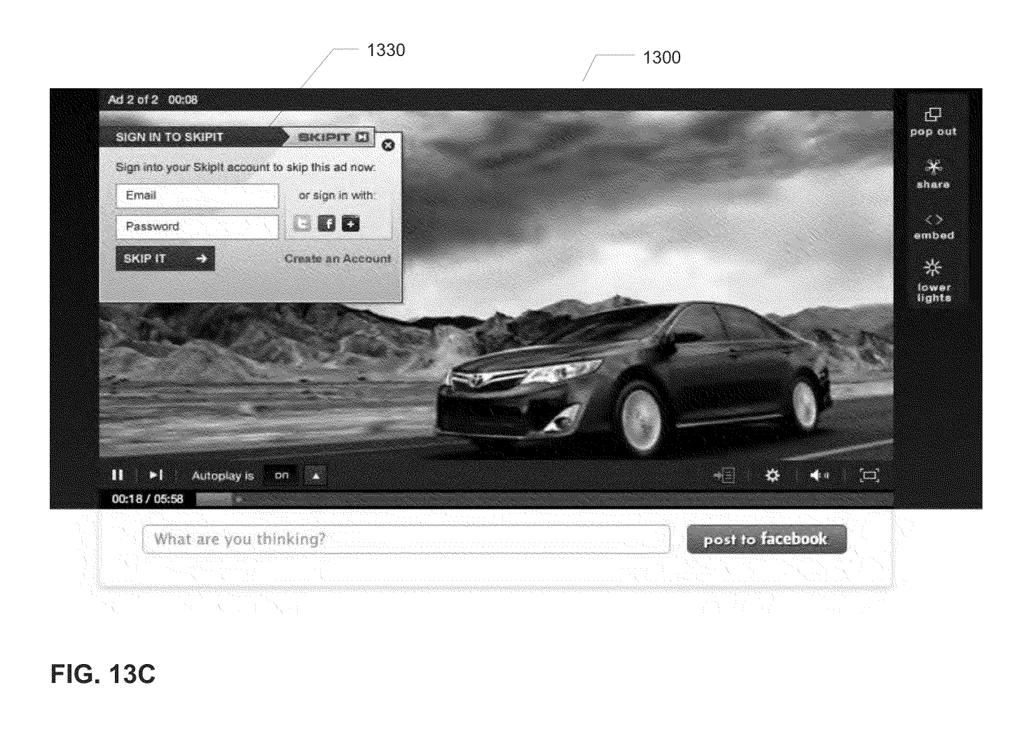

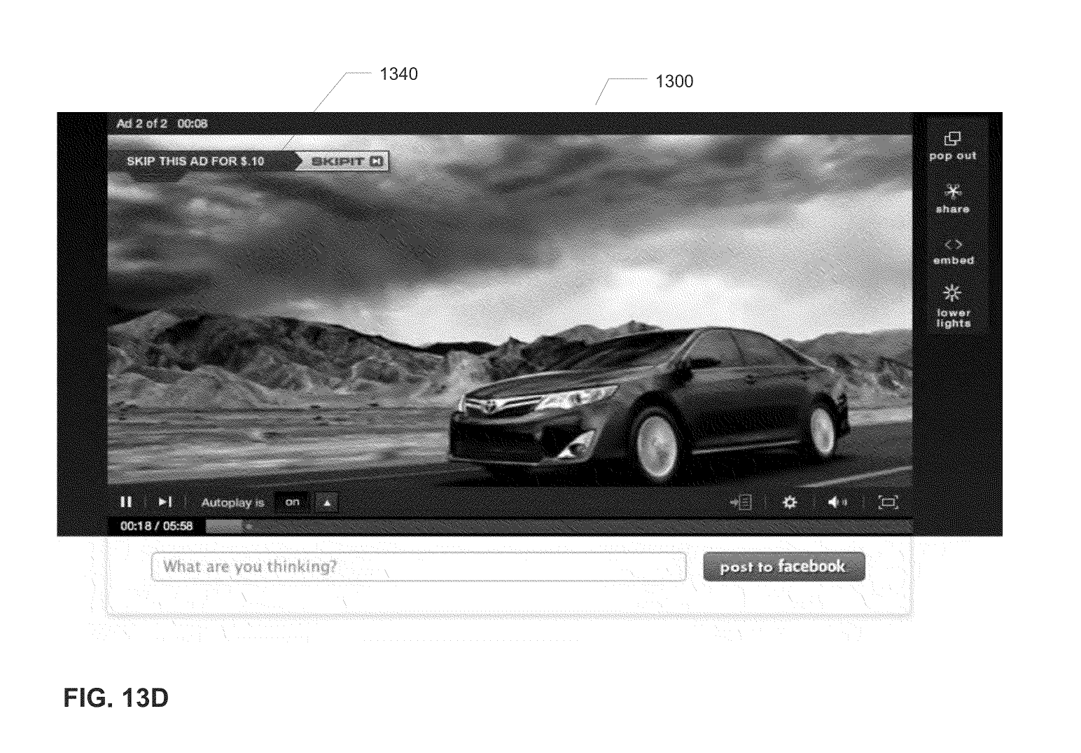

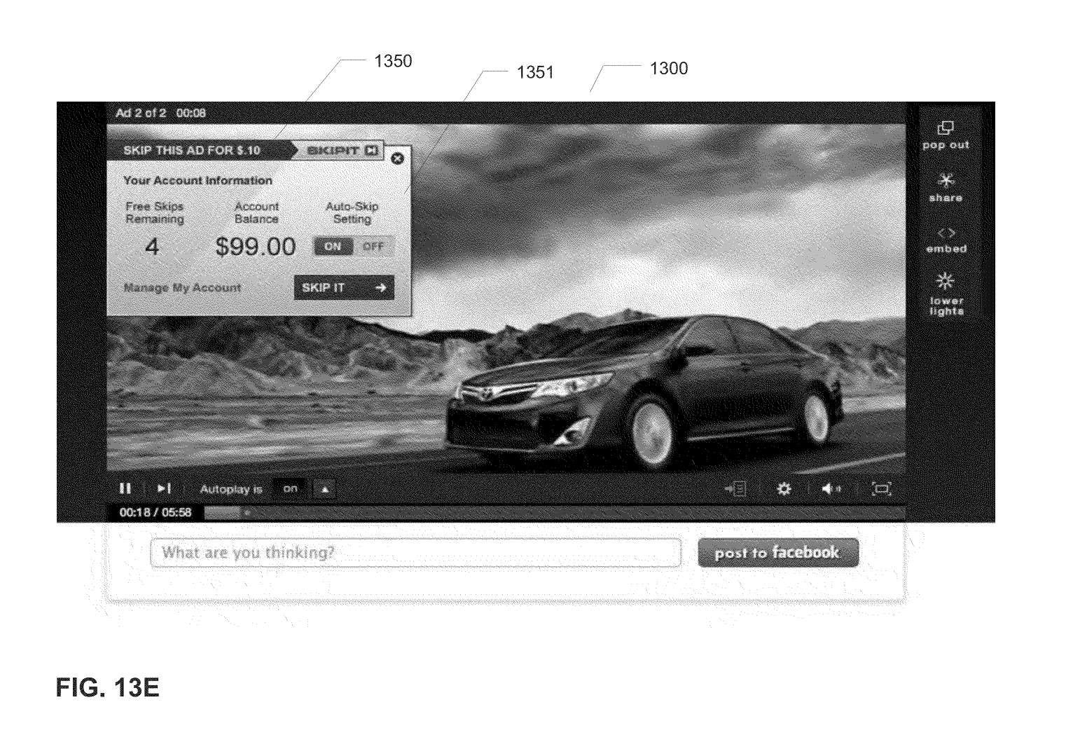

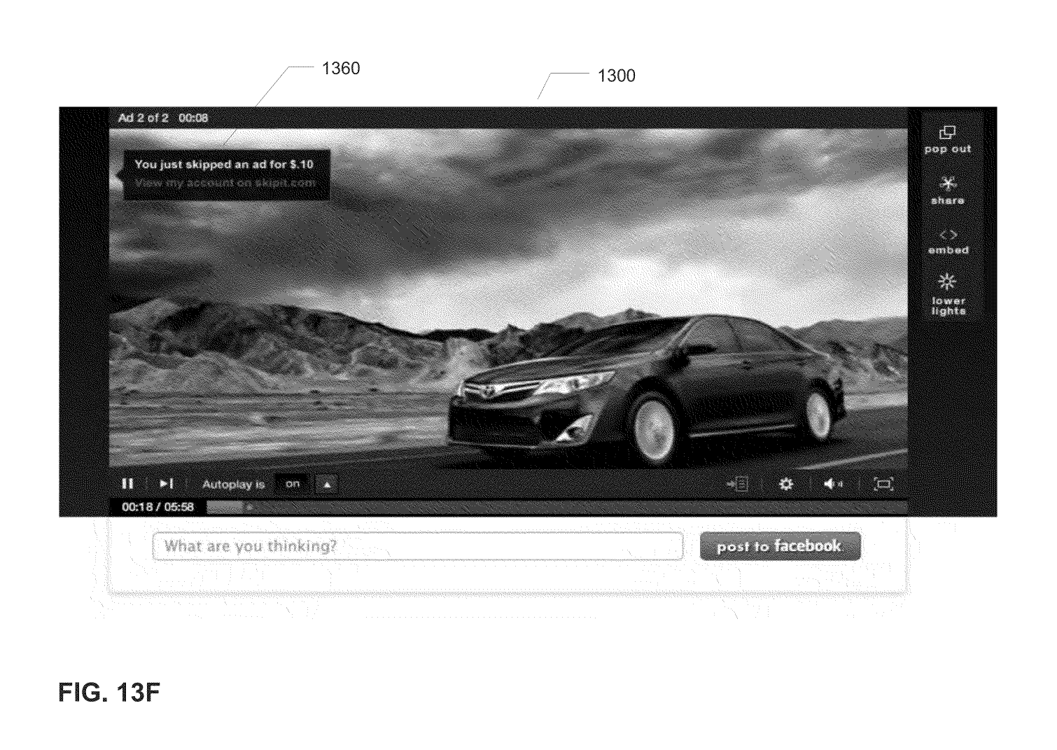

Briefly, in operation and as described in further detail below, an invite (e.g., an invitation to skip an ad) may be presented to a consumer by a publisher responsive to a request by the consumer for content hosted by the publisher, for example, concurrently with, during or prior to the presentation of a broadband video commercial or other advertising content. In one embodiment, the invite is presented in the form of an overlay widget displayed by the SkipOS during ad presentation as illustrated by FIGS. 13A-13F.

According to one embodiment, the SkipOS attests the opportunity to skip an electronic advertisement via an HTTP or HTTPS request to opportunity witness process 216 within publisher facilities 212 of ad skipping service 200. The attestation HTTP request may contain, among other parameters, a GUID identifying the specific impression opportunity (an opportunity GUID). In one embodiment, the attestation HTTP request is signed using a secret key of the publisher to provide non-repudiation for the opportunity. For example, a HMAC-SHA256 signature may be generated using the publisher's ad skipping service secret key.

Responsive to the attestation HTTP request, opportunity witness process 216 creates a “Skip Chain” to track the opportunity event and will “observe” (e.g., persistently cache, or pcache) opportunity datum associated with the chain. In one embodiment, all Skip Chain datum are stored and “swept” for later processing and registration in data warehouses via scoring and registration batch processors operable within event processing module 222. The datum in a Skip Chain may be correlated together via the opportunity GUID.

In some implementations, publishers may elect to optionally receive an asynchronous opportunity receipt provided directly from opportunity witness process 216 via an HTTP POST to a URL the publisher provided during registration, for example.

In one embodiment, the overlay widget displays the opportunity cost to the consumer and provides the consumer with the ability to get more information about his/her account cost as show in FIGS. 13A and 13E.

According to one embodiment, at all times during widget interaction the consumer is able to provide feedback (e.g., via social media) without losing their ad skipping service context.

Depending upon the particular implementation, if the consumer wants to skip an ad (e.g., a currently presented broadband video commercial), the consumer must have a sufficiently funded account with ad skipping service 200 or sufficient ad skipping credits (vouchers) to do so.

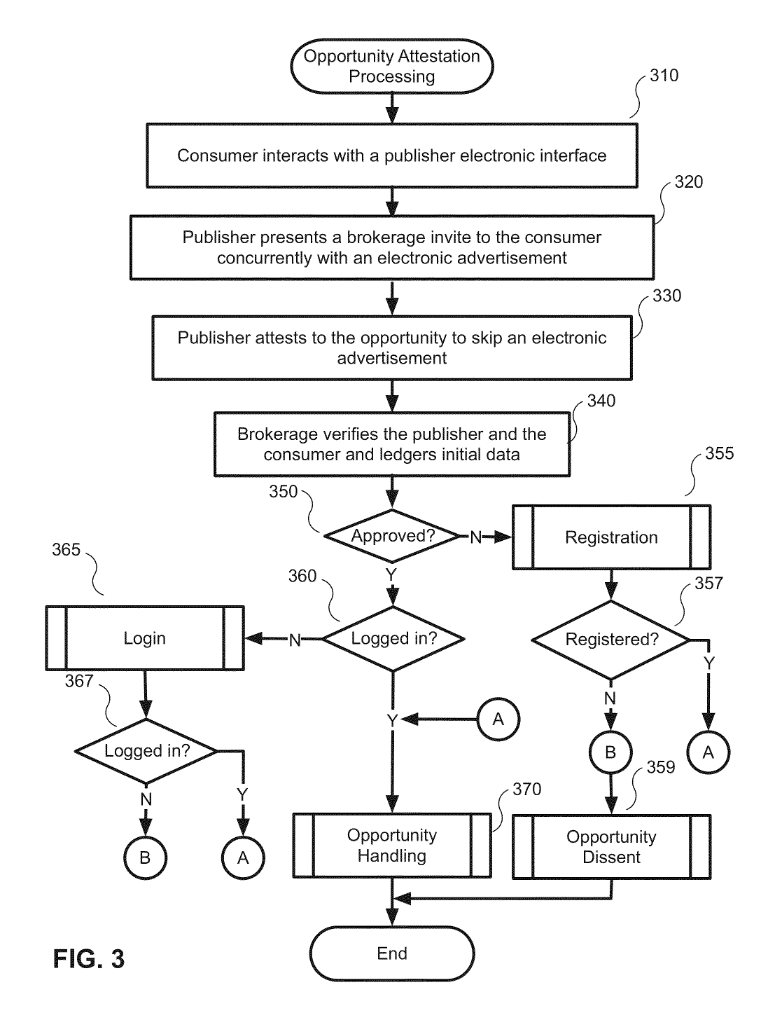

FIG. 3 is a flowchart illustrating opportunity attestation processing in accordance with an embodiment of the present invention. Depending upon the particular implementation, the various process and decision blocks described herein may be performed by hardware components, embodied in machine-executable instructions, which may be used to cause a general-purpose or special-purpose processor programmed with the instructions to perform the steps, or the steps may be performed by a combination of hardware, software, firmware and/or involvement of human participation/interaction.

At block 310, a consumer interacts with a publisher electronic interface. For example, consumer may be requesting to view content (e.g., broadband video content) made available on a partner publisher's web site. For purposes of the present example, it is assumed the provision of the requested content by the publisher to consumers is advertisement supported. As such, at some point before, during or after the content is displayed, an electronic advertisement (e.g., a broadband video commercial) will be displayed to the consumer—unless the electronic advertisement is skipped by the consumer as described further below.

At block 320, the publisher presents a brokerage invite to the consumer concurrently with an electronic advertisement. As described further below, in one embodiment, the invite is presented concurrently with the electronic advertisement in the form of a widget (e.g., overlaid over the electronic advertisement in the upper left-hand corner) as a result of execution of code associated with a SkipOS by the consumer's browser. According to one embodiment, the brokerage invite is displayed to the consumer responsive to an HTTP request to ad skipping service 200 requesting ActionScript or JavaScript.

At block 330, the publisher attests to the opportunity to skip the electronic advertisement. In one embodiment, once the brokerage invite is presented, the publisher attests to the opportunity through SkipOS API-based interaction with the ad skipping service 200 (e.g., the SkipOS communicating with opportunity witness process 216 via HTTP or HTTPS through a publisher API implemented therein). According to one embodiment the opportunity attestation includes, but is not limited to, one or more of the following:
The consumer's unique GUID/ID for their Brokerage account.
Publisher's ID
Channel ID
Timestamp
Opportunity Data
   Currency and cost to skip the electronic advertisement (e.g., opportunity cost in CPI or CPM)
   The referrer
   The “slot” (pre-roll, mid-roll, post-roll, time into long-form content, etc.)
Ad Information
   Duration of the ad
   Value of the Ad in CPM or CPI
   The Ad tag URL
   Advertiser identification (e.g., domain)
   The Publisher's ID for the ad
   The Ad's title
   The Ads media URL
Consumer Information
   Device information (e.g., platform, user agent, etc.)
   IP address
   Demographics
   History with the publisher
   Information the consumer has provided the publisher and allowed them to share
   Geo-location

At block 340, the brokerage (e.g., ad skipping service 200) verifies the publisher and the consumer and ledgers initial data. In one embodiment, opportunity witness process 216 confirms the publisher has an approved and active brokerage seat and the consumer had an active and approved brokerage account. The opportunity witness process 216 may also create and persistently store in real-time an opportunity ledger relating to the opportunity and including optional information about the advertisement being offered for skipping, the publisher and the consumer. The opportunity ledger may include information extracted from the opportunity attestation as well as other information, including, but not limited to: a unique GUID assigned to the impression opportunity, demographics about the consumer (e.g., some of which may be provided during the registration process and some of which may be available from a third party service profile as a result of the consumer's use of the third party service's single sign-on (SSO)), geo-location information, impression CPM worth and advertiser information.

At decision block 350, the SkipOS receives an HTTP response from the brokerage with indicating the success or failure of the verification performed in block 340. If the HTTP response indicates the consumer does not have an approved and active brokerage account with the ad skipping service 200, then opportunity attestation processing branches to block 355; otherwise, processing continues with decision block 360.

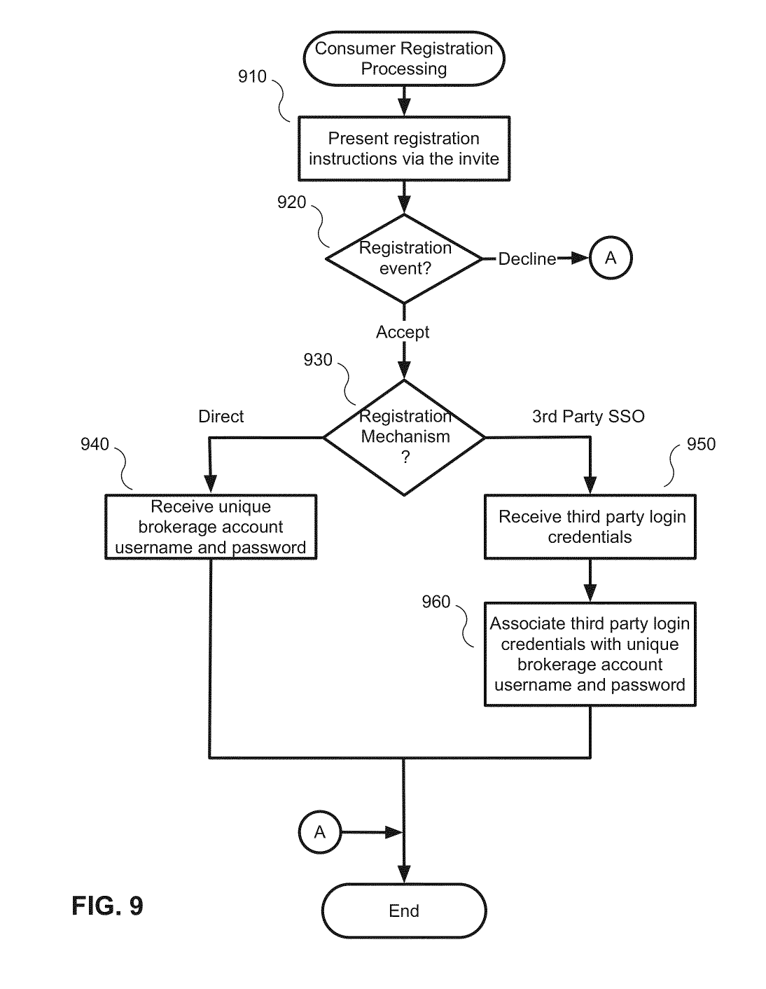

At block 355, it has been determined that the consumer does not have an active brokerage account with the ad skipping service 200. Consequently, the consumer is offered an opportunity to register via the brokerage invite. According to one embodiment, consumer registration processing is as described with reference to FIG. 9.

At decision block 357, a determination is made regarding whether the consumer successfully registered with the ad skipping service 200. If so, then opportunity attestation processing branches to block 370; otherwise processing continues with block 359.

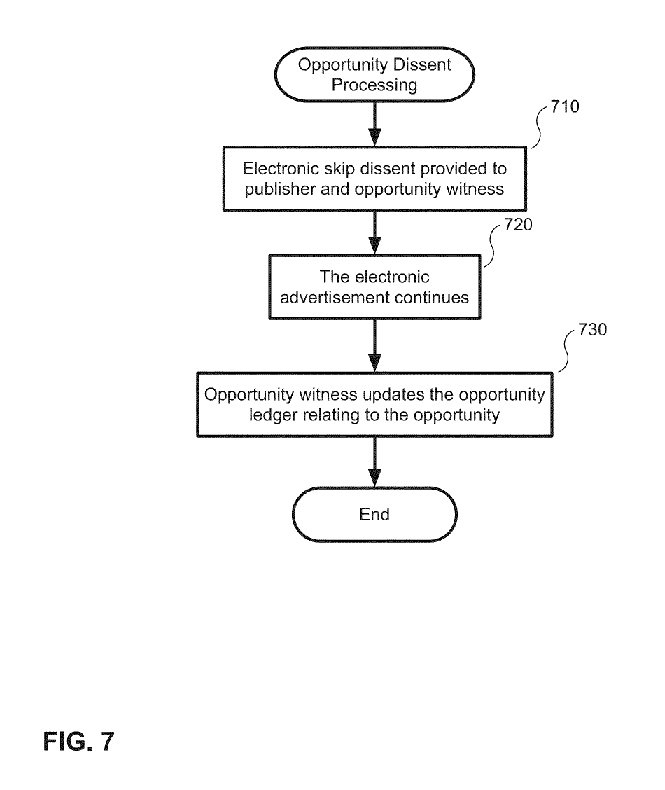

At block 359, the invitation to register with ad skipping service 200 has been declined by the consumer, therefore opportunity dissent processing is performed. Opportunity dissent processing may involve informing both the publisher and the brokerage of the consumer's implicit dissent to skipping of the electronic advertisement at issue. According to one embodiment, opportunity dissent processing is as described with reference to FIG. 7. At this point, opportunity attestation processing is complete.

At decision block 360, a determination is made regarding whether the registered consumer is currently logged in to their brokerage account. If so, then opportunity attestation processing continues with block 370; otherwise, processing branches to block 365.

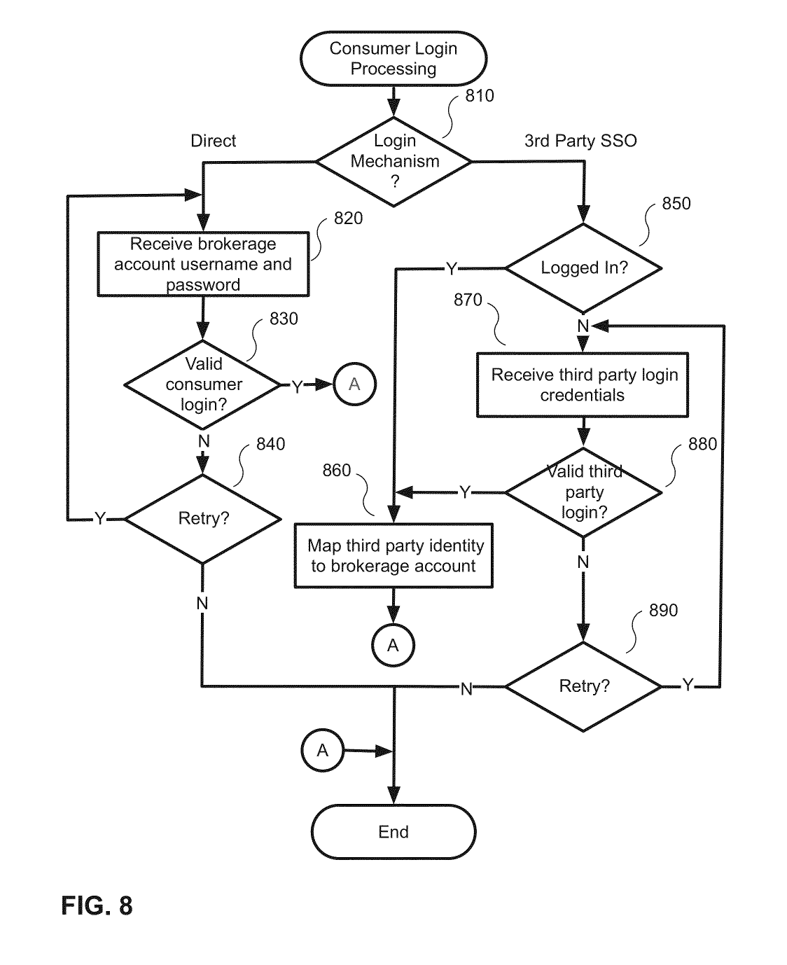

At block 365, it has been determined that the consumer does have a brokerage account with the ad skipping service 200, but the consumer is not currently logged in. Consequently, the consumer is provided with an opportunity to log into their brokerage account via the invite. According to one embodiment, consumer login processing is as described with reference to FIG. 8.

At decision block 367, a determination is made regarding whether the consumer successfully logged into their brokerage account with the ad skipping service 200. If so, then opportunity attestation processing branches to block 370; otherwise processing continues with block 359.

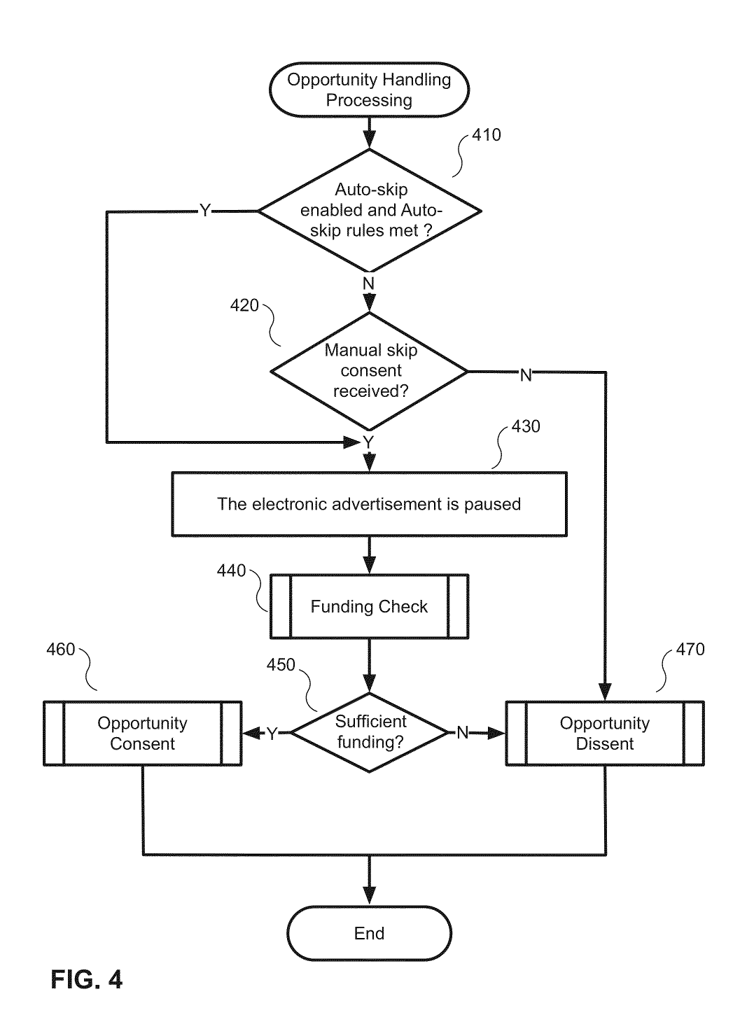

At block 370, it has been determined that the consumer is both registered and logged into their brokerage account, therefore opportunity handling processing is performed. Opportunity handling may involve applying auto-skip rules, allowing the consumer to manually skip the electronic advertisement at issue and checking whether the consumer's account is sufficiently funded to skip the electronic advertisement at issue. According to one embodiment, opportunity handling processing is as described with reference to FIG. 4. At this point, opportunity attestation processing is complete.

FIG. 4 is a flowchart illustrating opportunity handling processing in accordance with an embodiment of the present invention. At decision block 410, a determination is made regarding whether auto-skip functionality has been enabled by the consumer and if so, whether any defined auto-skip rules are met. If auto-skip has been enabled for the brokerage account and optionally defined auto-skip rules are satisfied, then opportunity handling processing branches to block 430; otherwise, processing continues with decision block 420.

According to one embodiment, consumers may optionally define auto-skip rules to communicate to ad skipping service 200 conditions under which auto-skipping is to be performed on behalf of the consumer. Exemplary auto-skip rules include, but are not limited to:
Automatically skip ads for specific publishers and/or channels.
Automatically skip ads only during a particular login session.
Automatically skip ads only during the current content session.
Automatically skip ads having durations greater than a customizable threshold.
Automatically skip ads having a skip cost (e.g., CPM or CPI) of less than or equal to a customizable threshold.
Automatically skip ads only if skip vouchers are present.
Automatically skip ads only if the account balance is greater than or equal to a customizable threshold amount of funds.

At decision block 420, either auto-skip is inactive or no auto-skip rules are met, therefore the consumer is given an opportunity to manually consent to skipping of the electronic advertisement at issue. According to one embodiment, the invite gives the consumer electronic means of interacting with the invite, including providing the consumer with information regarding the cost to skip the ad at issue and prompting the consumer for permission to manually skip the ad at issue. In one embodiment, the means of interacting with the invite is temporary (e.g., the first 5 to 10 seconds of the advertisement). If, via interactions with the overlay widget, the consumer expresses his/her desire to manually skip the ad at issue and incur the associated cost, then opportunity handling processing continues with block 430; otherwise processing branches to block 470. Notably, in embodiments of the present invention, the consumer's brokerage account will not be charged (and the publisher's account will not be credited) unless an explicit consent is observed by the opportunity witness process 216 as a result of explicit manual consent received from the consumer or triggering of an auto-skip rule.

At block 470, explicit consent to skip the ad at issue was not received from the consumer. As such, opportunity dissent processing is performed to communicate the consumer's implicit dissent to skipping of the ad at issue to the publisher and the brokerage. According to one embodiment, opportunity dissent processing is as described with reference to FIG. 7. At this point, opportunity handling processing is complete.

At block 430, the electronic advertisement is temporarily paused. In one embodiment, the SkipOS advises the publisher of the consumer's expressed desire to skip the ad at issue and responsive thereto, the publisher temporarily pauses the ad to allow the brokerage an opportunity to perform funding check processing at block 440.

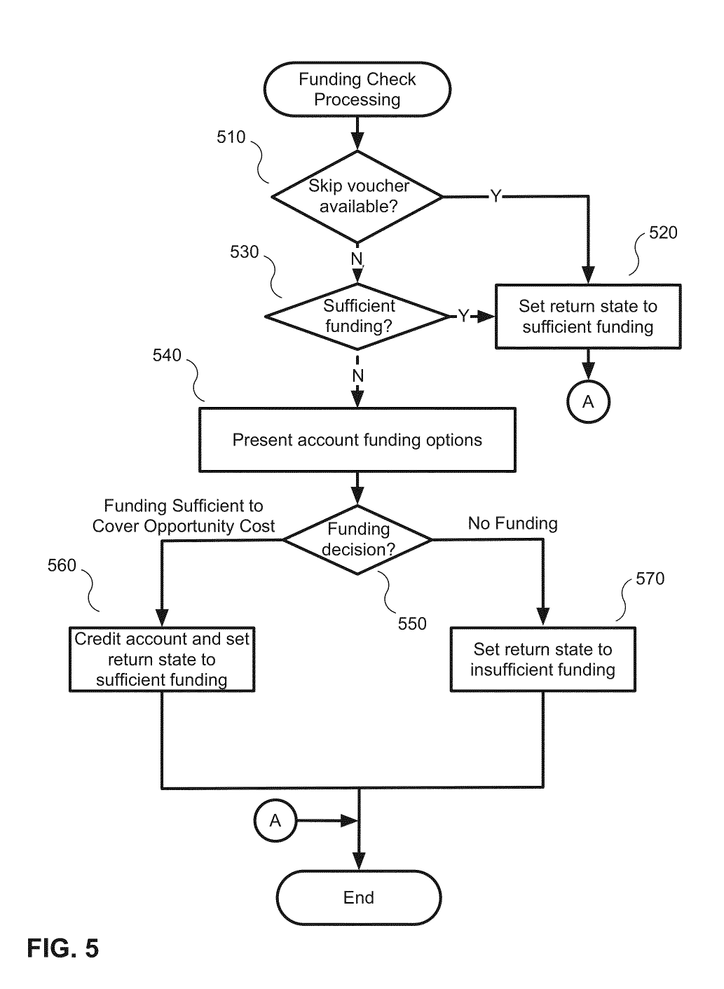

At block 440, funding check processing is performed. According to one embodiment funding check processing includes, among other things, determining whether the consumer has sufficient funding or skip vouchers to skip the ad at issue. According to one embodiment, funding check processing is as described with reference to FIG. 5.

At decision block 450, a determination is made whether the funding check processing determined or ultimately resulted in the consumer's account being sufficiently funded. If so, then opportunity handling processing continues to block 460; otherwise processing branches to block 470.

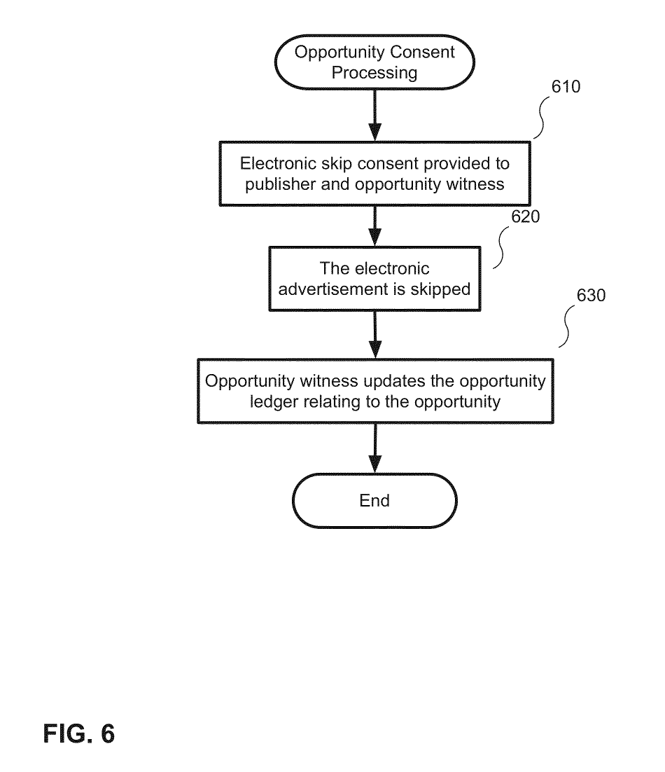

At block 460, explicit consent to skip the ad at issue has been received from the consumer. As such, opportunity consent processing is performed to communicate the consumer's consent to skipping the ad at issue to the publisher and the brokerage. According to one embodiment, opportunity consent processing is as described with reference to FIG. 6. At this point, opportunity handling processing is complete.

FIG. 5 is a flowchart illustrating funding check processing in accordance with an embodiment of the present invention. At decision block 510, a determination is made regarding whether a skip voucher is available in the consumer's brokerage account. If so, then funding check processing branches to block 520; otherwise processing continues with decision block 530.

At block 520, the state to be returned to the calling process is set to “sufficient funding” and funding check processing is complete.

At decision block 530, a determination is made regarding whether the consumer's account has sufficient monetary funding to pay to skip the ad at issue. According to one embodiment, the consumer's brokerage account must have a monetary amount greater than or equal to the CPI specified in the opportunity attestation. If an affirmative decision is made regarding the sufficiency of the funding, then funding check processing branches to block 520; otherwise processing continues with block 540.

At block 540, it has been determined that the consumer's brokerage account is not sufficiently funded to skip the ad at issue. Consequently, the consumer is presented with one or more account funding options. According to one embodiment, the SkipOS is directed by the brokerage to display various funding options (e.g., do not fund the account, fund the account by charging a configurable dollar amount to a credit card designated during the consumer registration process) via the invite.

At decision block 550, the consumer's funding decision is received via the invite. If the consumer has chosen not to fund their brokerage account, then funding check processing branches to block 570. If the consumer has chosen to fund their brokerage account with funding sufficient to cover the opportunity cost of the ad at issue, then funding check processing continues with block 560. Note in some embodiments, the consumer is provided with the ability to automatically fund their account with a configurable dollar amount (e.g., $20) upon the account balance falling below a configurable threshold (e.g., $5). Alternatively, the consumer may authorize the brokerage to automatically fund their account with a configurable amount (e.g., $10) on a periodic basis (e.g., once a month) from a designated source (e.g., bank account, credit card, online wallet or mobile payment).

At block 560, assuming the designated source account authorizes the specified transaction, the consumer's brokerage account is credited, the state to be returned to the calling process is set to “sufficient funding” and funding check processing is complete.

At block 570, the consumer has declined to sufficiently fund their brokerage account; therefore, the state to be returned to the calling process is set to “insufficient funding” and funding check processing is complete.

FIG. 6 is a flowchart illustrating opportunity consent processing in accordance with an embodiment of the present invention. At block 610, an electronic skip consent is provided to the publisher and opportunity witness process 216. Information contained within the electronic skip consent may include, but is not limited to:
Publisher ID
Channel ID
The advertising opportunity ID assigned by the brokerage in response to the opportunity attestation.
Information regarding the referrer
The Consumer GUID.
Timestamp
The skip cost
Consumer information (similar to that included in an opportunity attestation, which may be used for fraud detection, for example)
Geo-location

According to one embodiment, explicit skip consent is received from the consumer (e.g., via auto-skip settings or manually via the invite) and communicated to the publisher and opportunity witness process 216 by the SkipOS.

At block 620, the electronic advertisement at issue is skipped. According to one embodiment, responsive to receipt of the skip consent from the SkipOS, the publisher causes the electronic advertisement to terminate and continues with the content originally requested by the consumer.

At block 630, opportunity witness process 216 updates the opportunity ledger relating to the advertising opportunity. According to one embodiment, the opportunity ledger may be updated to include, among other things, one or more pieces of information extracted from the skip consent. The Brokerage may register the advertising opportunity as explicitly consented in the ledger. The Brokerage may also snapshot the consumer's current balances and available vouchers behind the scenes and associate.

Additionally, if payment allocation processing is performed in real-time, the brokerage would typically debit the consumer's brokerage account and credit the publisher's account at this point. This payment allocation process is similar to an authorization/capture (approve and charge at the same time) with a credit card.

In alternative embodiments, such payment allocation processing may be performed as a background or a batch process on a periodic basis (e.g., hourly, daily, etc.). In such an embodiment, the brokerage would typically cache transactions in a pending state so consumers would be able to see the opportunities waiting for final clearance and so a consumer's account would not be allowed to go negative. This type of payment allocation process is similar to a delayed capture for credit cards.

Notably, various embodiments of the present invention seek to ensure accuracy and prevent potential fraud by charging a consumer's brokerage account and crediting a publisher's account only after verifying a correlation between an explicit and valid skip consent by the consumer with a corresponding opportunity attestation by the publisher.

Validation is made simple by the fact that the brokerage has a non-repudiated consumer (e.g., logged in and whose security token is held by the brokerage) and the publisher has been approved for every attestation. The brokerage may also implement post-opportunity fraud algorithms that run to detect bots, uniform interactions, multi-burn by publishers and the like.

FIG. 7 is a flowchart illustrating opportunity dissent processing in accordance with an embodiment of the present invention. At block 710, an electronic skip dissent is provided to the publisher and opportunity witness process 216. According to one embodiment, information contained within the electronic skip dissent is similar to that of an electronic skip consent. According to one embodiment, if explicit skip consent is not timely received from the consumer (e.g., via auto-skip settings or manually via the invite), then a skip dissent is communicated to the publisher and opportunity witness process 216 by the SkipOS.

At block 720, the electronic advertisement at issue is resumed (un-paused). According to one embodiment, responsive to receipt of the skip dissent from the SkipOS, the publisher causes the electronic advertisement to continue and the consumer is presented with the content originally requested after completion of electronic advertisement.

At block 730, opportunity witness process 216 updates the opportunity ledger relating to the opportunity. According to one embodiment, the opportunity ledger may be updated to include, among other things, one or more pieces of information extracted from the skip dissent. The Brokerage may register the advertising opportunity as explicitly dissented in the ledger. Importantly, because the consumer has not consented to skipping the ad at issue, the publisher's account is not credited with the corresponding skip cost for this advertising opportunity and the consumer's account is not debited.

FIG. 8 is a flowchart illustrating consumer login processing in accordance with an embodiment of the present invention. According to one embodiment, when a registered consumer that is not currently logged in to his/her brokerage account is presented with an opportunity to skip an electronic advertisement, the invite may prompt the consumer to login as illustrated in FIGS. 13A and 13C. At decision block 810, a determination is made regarding the consumer's desired authentication method based on input received from the consumer on the login prompt presented via the invite. If the consumer choses to sign in directly then consumer login processing continues with block 820; otherwise, if the consumer choses to use a third party single sign-on (SSO) (e.g., sign in with Twitter, Facebook or Google+), the processing branches to decision block 850.

At block 820, a brokerage account username and password are received. According to one embodiment, the brokerage account username is an email address provided by the consumer during a prior registration process. In one embodiment, the username and password are received via the SkipOS and communicated by the SkipOS via HTTP or HTTPS to login/registration process 213 via an API associated with consumer facilities 211.

At decision block 830, a determination is made regarding whether the consumer login credentials are valid. According to one embodiment, login/registration process 213 may use a well-known login authentication mechanism, such as a Radius server or the like. If login/registration process 213 confirms the validity of the consumer login credentials, then the state of the consumer's brokerage account is set to a “logged in” state and consumer login processing is complete; otherwise, processing continues with decision block 840. In some embodiments, the consumer may be provided with an ability to persist their logged in state for a predetermined amount of time or for a particular domain.

At decision block 840, the consumer's login attempt failed and based on input from the consumer a determination is made regarding whether to make another login attempt. If the consumer indicates he/she would like to retry, then consumer login processing loops back to block 820 at which point the consumer reenters his/her login credentials; otherwise, consumer login processing is terminated.

At decision block 850, a determination is made regarding whether the consumer is currently logged in to the designated third party service. If so, then consumer login processing branches to block 860; otherwise processing continues with block 870.

At block 860, the third party identify is mapped to the corresponding consumer brokerage account designated during an earlier consumer registration process, the consumer's brokerage account is set to a “logged in” state and consumer login processing is complete.

At block 870, it has been determined that the consumer is not currently logged into specified third party SSO service; therefore, the consumer is prompted to provide their login credentials for the third party SSO service and upon receipt the login credentials are sent to the third party SSO service for authentication.

At decision block 880, a determination is made regarding whether the third party SSO service indicated the login credentials were valid. If the third party SSO service confirms the validity of the consumer-provided login credentials, then consumer login processing branches to block 860; otherwise, processing continues with decision block 890.

At decision block 890, the consumer's login attempt via the third party SSO service failed and based on input from the consumer a determination is made regarding whether to make another login attempt. If the consumer indicates he/she would like to retry, then consumer login processing loops back to block 870 at which point the consumer reenters the third party SSO service login credentials; otherwise, consumer login processing is terminated.

FIG. 9 is a flowchart illustrating consumer registration processing in accordance with an embodiment of the present invention. According to one embodiment, when a consumer that is not registered with the ad skipping service 200 is presented with an opportunity to skip an electronic advertisement, at block 910, the invite may prompt the consumer to register as illustrated in FIGS. 13A and 13B.

At decision block 920, a determination is made regarding the consumer's registration decision. If the consumer accepts the registration invitation, then consumer registration processing continues with decision block 930; otherwise, if the consumer declines the registration invitation (e.g., expressly or by failing to timely respond), then consumer registration processing is terminated.

At decision block 930, a determination is made regarding the consumer's desired registration mechanism based on input received from the consumer on the registration prompt presented via the invite. If the consumer choses to register directly then consumer registration processing continues with block 940; otherwise, if the consumer choses to use a third party single sign-on (SSO) (e.g., sign in with Twitter, Facebook or Google+), the processing branches to block 950.

At block 940, the consumer provides a brokerage account username and password. Assuming the username is unique within the ad skipping service 200, registration is complete and the consumer may now proceed to log into the account.

At block 950, the consumer provides third party login credentials, which at block 950, are associated with a unique brokerage account username and password. At this point, registration is complete and the consumer may now proceed to log into the account.

According to one embodiment, participating publishers also register with the brokerage via an electronic portal, for example. In one embodiment, each participating publisher is assigned a unique brokerage seat ID within the brokerage. During the registration process, publishers may identify the currencies they accept, skip cost baselines per channel, channels and their referrer URLs, business information, contact information for various roles (e.g., admin, billing, technical, etc.).

Typically, publishers are approved via human and/or machine mechanisms. For example, integration of the SkipOS by the publisher may be tested and approved on a channel-by-channel basis in a “sandbox” mode before the brokerage allows a particular channel to go live.

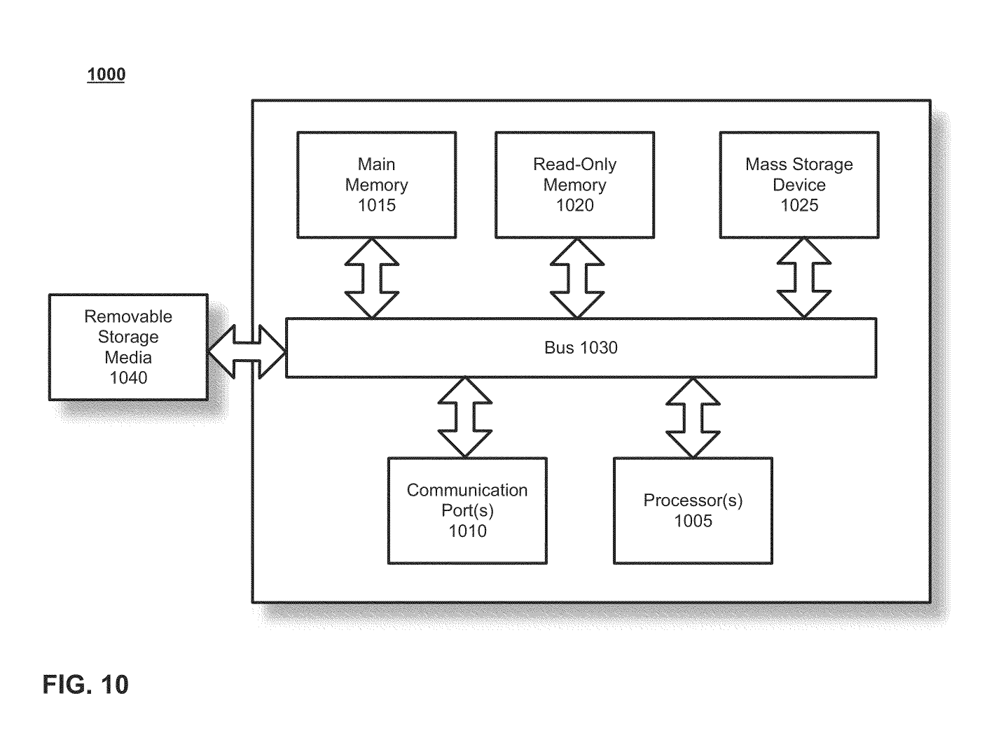

FIG. 10 is an example of a computer system with which embodiments of the present invention may be utilized. Embodiments of the present invention include various steps, a variety of which may be performed by hardware components or may be tangibly embodied on a non-transitory computer-readable storage medium in the form of machine-executable instructions, which may be used to cause a general-purpose or special-purpose processor programmed with instructions to perform these steps. Alternatively, the steps may be performed by a combination of hardware, software, and/or firmware. As such, FIG. 10 is an example of a computer system 1000, such as a consumer's personal computer, laptop, mobile device or the like or a server associated with a publisher or ad skipping service 200, upon which or with which embodiments of the present invention may be employed.

According to the present example, the computer system includes a bus 1030, one or more processors 1005, one or more communication ports 1010, a main memory 1015, a removable storage media 1040, a read only memory 1020 and a mass storage 1025.

Processor(s) 1005 can be any future or existing processor, including, but not limited to, an Intel® Itanium® or Itanium 2 processor(s), or AMD® Opteron® or Athlon MP® processor(s), or Motorola® lines of processors. Communication port(s) 1010 can be any of an RS-232 port for use with a modem based dialup connection, a 10/100 Ethernet port, a Gigabit port using copper or fiber or other existing or future ports. Communication port(s) 1010 may be chosen depending on a network, such a Local Area Network (LAN), Wide Area Network (WAN), or any network to which the computer system 1000 connects.

Main memory 1015 can be Random Access Memory (RAM), or any other dynamic storage device(s) commonly known in the art. Read only memory 1020 can be any static storage device(s) such as Programmable Read Only Memory (PROM) chips for storing static information such as start-up or BIOS instructions for processor 1005.

Mass storage 1025 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 1030 communicatively couples processor(s) 1005 with the other memory, storage and communication blocks. Bus 1030 can include a bus, such as a Peripheral Component Interconnect (PCI)/PCI Extended (PCI-X), Small Computer System Interface (SCSI), USB or the like, for connecting expansion cards, drives and other subsystems as well as other buses, such a front side bus (FSB), which connects the processor(s) 1005 to system memory.

Optionally, operator and administrative interfaces, such as a display, keyboard, and a cursor control device, may also be coupled to bus 1030 to support direct operator interaction with computer system 1000. Other operator and administrative interfaces can be provided through network connections connected through communication ports 1010.

Removable storage media 1040 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the invention.

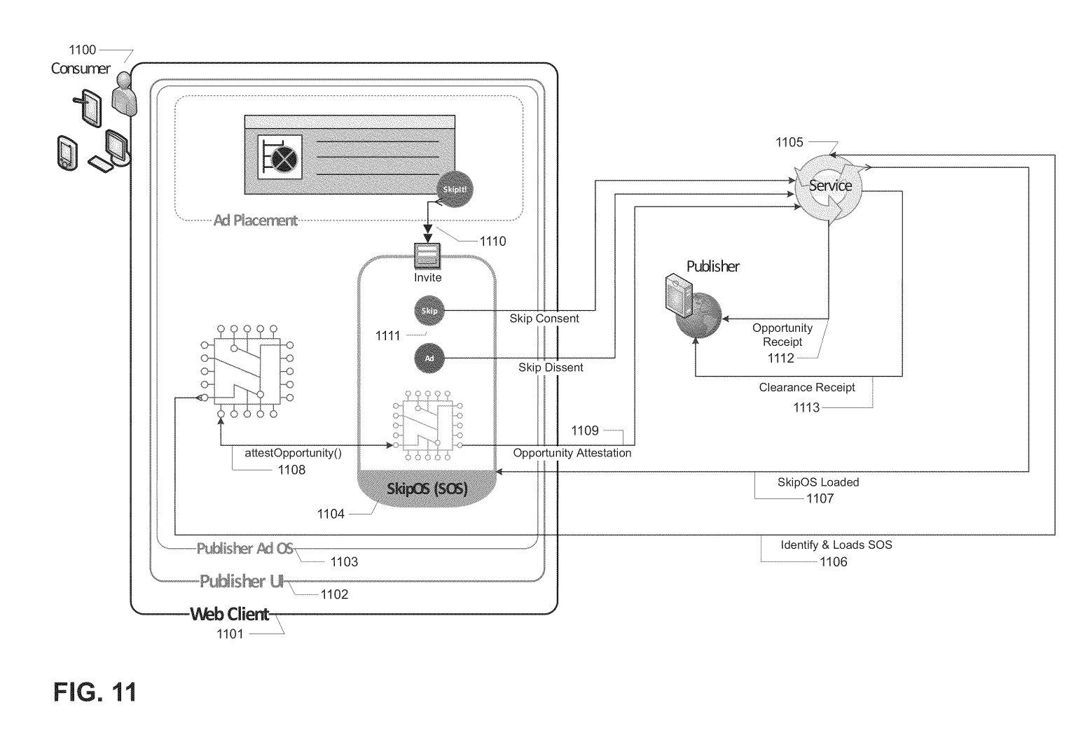

FIG. 11 is a high-level diagram that conceptually illustrates the integration of a publisher electronic interface with a brokerage skip operating system (SkipOS) and interactions between them and a consumer 1110 in accordance with an embodiment of the present invention. The present example conceptually illustrates how the publisher integrates SkipOS 1104. The model depicted can apply linearly (e.g., blocking the ad display until the consumer interacts with the brokerage invite) or non-linearly (e.g., showing the brokerage invite concurrently with the ad start).

In the context of the present example, web client 1101 represents the consumer's browser, publisher user interface (UI) 1102 represents a channel's electronic interface, publisher ad OS 1103 is the code the publisher uses to control ad display and with which SkipOS 1104 is integrated and driven by and service 1105 represents the ad skipping service, e.g., ad skipping service 200, implemented within the electronic brokerage, e.g., brokerage 100. Depending upon the particular implementation, SkipOS 1104 may be implemented in ActionScript, JavaScript or another language.

AttestOpportunity( ) 1108 represents publisher ad OS 1103 telling SkipOS 1104 there is an advertising opportunity. This in turn causes SkipOS 1104 to perform an opportunity attestation 1109. In one embodiment, opportunity attestation 1109 is bi-directional, thereby allowing service 1105 to assign an opportunity ID to the advertising opportunity and allowing SkipOS 1104 to inform publisher ad OS 1103 of the opportunity ID and if an auto-skip happened, the opportunity was approved, etc.

Reference numeral 1110 represents SkipOS 1104 displaying a brokerage invite in response to 1108/1109. If the electronic advertisement is auto-skipped, the invite tells consumer 1100 via a glyph/growler and the ad is skipped; otherwise, the invite gives consumer 1100 a chance to consent/dissent, register, fund, etc.

Reference numeral 1111 represents SkipOS 1104 dealing with an explicit consent/dissent. As described above, if consumer 1100 does nothing, an implicit dissent is taken. The various flows outside of Web client 1101 are similar to those as described above.

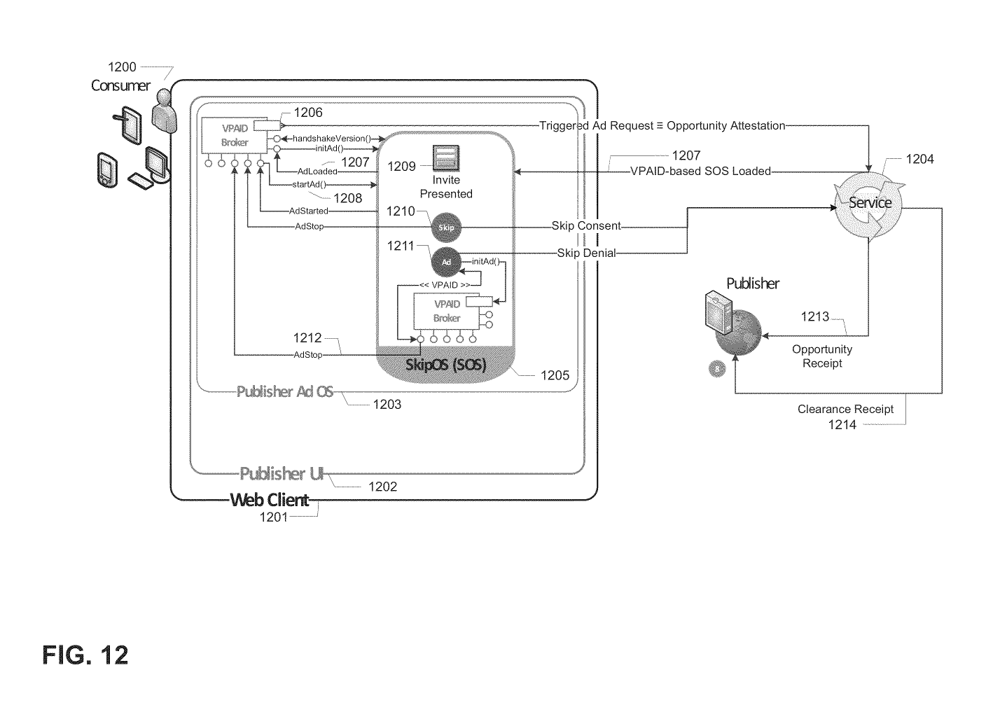

FIG. 12 is a high-level diagram that conceptually illustrates the integration of a publisher electronic interface with a brokerage skip operating system (SkipOS) 1205 and interactions between them and a consumer 1200 in accordance with an alternative embodiment of the present invention. The present example conceptually illustrates integrating SkipOS 1205 inside a VPAID container (an IAB spec for ad communication in a client). This model works in a manner similar to that of FIG. 11; however, illustrates how an advertiser could use SkipOS 1205. In this manner, advertisers would be allowed to have seats independent of a publisher if they wanted. The option to skip would be given by the ad itself, regardless of whether or not the publisher also has a seat. In this manner, an advertiser could offer ad skipping to consumers independent of a publisher's participation in ad skipping service 200.

In cases in which both the advertiser and the publisher have a seat, SkipOS 1205 defers control to the publisher over the advertiser and the publisher seat would be paid for skipped electronic advertisements and the advertiser would be credited.

Before moving on to describe various screenshots illustrating exemplary interactions with brokerage invites, it is worth noting that the electronic brokerage model described herein also facilitate probabilistic determination of advertising inventory characteristics based on skip consents and multidimensional forecasting of advertising inventory considering consumer-initiated payment to skip electronic advertisement.

According to one embodiment, characteristics of advertising inventory are implied by analyzing the interactions, behaviors and skip consent/dissents, both implicit dissent and explicit dissent, of consumers with various electronic advertisements. Based on information already known regarding the consumer by the electronic brokerage, including but not limited to skip history, demographics, intenders, time-of-day behaviors, etc., inventory characteristics can be modeled and applied against the various metadata about the advertisements offered within that inventory. This could, for example, determine the types of ads likely to be skipped, the types not likely to be skipped, the types of consumers skipping various advertisements, implying consumer characteristics by probabilistically casting characteristics on them, etc.

Techniques such as classification and regression tree (CART) analysis or artificial neural network (ANN) applications can take both inventory, advertisement and consumer metadata as inputs to develop and apply models to predictive futures modeling of inventory. From these models, the electronic brokerage may offer publishers dynamic mechanisms to ensure the best opportunity costs are offered to consumers specific to them and their viewing context.

FIG. 13A is a screenshot of an electronic advertisement 1300 having overlaid thereon a brokerage invite 1310 explaining the brokerage offering to the consumer and providing mechanisms for the consumer to either register with the brokerage or log into their existing account according to one embodiment of the present invention. According to one embodiment, brokerage invite 1310 is displayed to a consumer that either does not have a brokerage account with ad skipping service 200 or a consumer that does have a brokerage account with ad skipping service 200, but is currently logged out.

According to the present example, brokerage invite 1310 includes an expanded portion 1311 that explain the ad skipping service 200 and encourages the consumer to create a brokerage account. In one embodiment, the brokerage invite 1310 may be temporarily presented (e.g., during the first 5 to 10 seconds of electronic advertisement 1300) without expanded portion. If there is no interaction with brokerage invite 1310 by the consumer, brokerage invite 1310 may be minimized or removed from the electronic advertisement 1300. If the consumer interacts with brokerage invite 1310 (e.g., by clicking on the “Want to Skip this Ad” portion), expanded portion 1311 may be displayed to further explain the opportunity and electronic advertisement 1300 may be paused to allow the consumer an opportunity to explore ad skipping service 200 (e.g., create an account).

Responsive to selection of the “Create Account” button by the consumer, brokerage invite 1310 may be displayed as shown in FIG. 13B. Responsive to selection of the “Sign In” button by the consumer, brokerage invite 1310 may be displayed as shown in FIG. 13C.

FIG. 13B is a screenshot of an electronic advertisement 1300 having overlaid thereon a brokerage invite 1320 walking a consumer through registering an account with a brokerage according to one embodiment of the present invention. According to one embodiment, brokerage invite 1320 is displayed in the form depicted responsive to the consumer selecting the “Create Account” button of brokerage invite 1310 of FIG. 13A.

According to the present example, signing up for a brokerage account involves the consumer specifying a unique username (e.g., a unique email address) and a password (e.g., a four-digit alphanumeric string). Alternatively, the consumer may create a brokerage account with a third party service's single sign-on (SSO) service. For example, the consumer use his/her Twitter, Facebook or Google+ credentials to create a consumer brokerage account.

FIG. 13C is a screenshot of a an electronic advertisement 1300 having overlaid thereon a brokerage invite 1330 prompting a consumer to log into an existing account, allowing for third party authentication mechanisms according to one embodiment of the present invention. According to one embodiment, brokerage invite 1330 is displayed in the form depicted responsive to the consumer selecting the “Sign In” button of brokerage invite 1310 of FIG. 13A.

FIG. 13D is a screenshot of an electronic advertisement 1300 having overlaid thereon a brokerage invite 1340 offering a consumer the opportunity to skip an electronic advertisement according to one embodiment of the present invention. According to one embodiment, brokerage invites are presented in the form depicted when (as indicated by a cookie stored on the consumer's computer system, for example) the consumer has a brokerage account with ad skipping service 200 and is currently logged in. In the present example, brokerage invite 1340 may be selected by the consumer to allow the consumer to view additional account information, such as a number of free skips remaining, a current account balance and a current auto-skip setting, as shown in FIG. 13E.

FIG. 13E is a screenshot of an electronic advertisement 1300 having overlaid thereon a brokerage invite 1350 displaying account information to a consumer according to one embodiment of the present invention. According to one embodiment, brokerage invite 1350 is displayed in the form depicted responsive to the consumer selecting the “Skip This Ad For $0.10” portion of brokerage invite 1340 of FIG. 13D.

In the present example, additional account information is displayed within an expanded portion 1351 of brokerage invite 1350. According to one embodiment, the consumer may toggle the auto-skip setting via expanded portion 1351. In one embodiment, when auto-skip is enabled, electronic advertisements are automatically skipped if they meet criteria specified by the consumer and if sufficient funds or skip vouchers are available in the consumer's brokerage account.

FIG. 13F is a screenshot of an electronic advertisement 1300 having overlaid thereon a brokerage growler 1360 informing a consumer that they just successfully paid for skipping the electronic advertisement 1300 according to one embodiment of the present invention. According to one embodiment, growler 1360 is displayed to provide feedback to the consumer when electronic advertisement 1300 is automatically skipped (e.g., when auto-skip is enabled for the consumer's brokerage account and sufficient funding or skip vouchers are available in the account).

1. A method comprising:
responsive to a consumer requesting advertising-supported content of a website of a publisher, receiving, by a computer system of an electronic brokerage, an opportunity attestation from the publisher, wherein the opportunity attestation indicates to the electronic brokerage that the publisher has offered the consumer an opportunity to skip an advertising opportunity associated with the advertising-supported content (“skip opportunity”) in exchange for money or credits within a brokerage account of the consumer that is maintained by the electronic brokerage; and
when the electronic brokerage has received an electronic skip consent initiated by the consumer indicating the consumer has explicitly consented to the skip opportunity and the electronic brokerage has affirmatively verified the brokerage account satisfies one or more conditions, then causing the publisher to skip or discontinue presenting an advertisement to the consumer that is associated with the advertising opportunity.

2. (canceled)

3. The method of claim 1, wherein the opportunity attestation is made electronically by the publisher to the electronic brokerage either immediately prior to the advertising opportunity or in conjunction with a start of the advertising opportunity via a Hypertext Transport Protocol (HTTP) based Application Programming Interface (API) implemented within the electronic brokerage.

4. The method of claim 3, further comprising generating and assigning, by the electronic brokerage, globally unique identifiers (GUIDs) specific to the opportunity attestation and the consumer.

5. The method of claim 3, wherein the opportunity attestation comprises data about an opportunity cost in terms of a cost per impression (CPI) set by the publisher that is specific to the advertising opportunity and required to be paid by the consumer in order to skip the advertisement.

6. The method of claim 3, wherein the opportunity attestation contains additional data including one or more of metadata about the advertisement and metadata about an advertiser representing the advertising opportunity.

7. The method of claim 5, wherein the CPI is defined in a currency and denomination specified by the publisher either as part of their brokerage seat with the electronic brokerage or as part of the opportunity attestation.

8. The method of claim 5, further comprising leveraging, by the electronic brokerage, current currency exchange rates to convert the opportunity cost to a currency and denomination appropriate for the consumer according to preferences associated with the brokerage account.

9. The method of claim 6, further comprising ensuring, by the electronic brokerage, the opportunity attestation is a non-repudiated agreement on behalf of the publisher to:
forgo displaying of the advertisement to the consumer in exchange for a payment equivalent to the opportunity cost made by the consumer to the electronic brokerage; and
ensure the advertiser is not charged for the advertising opportunity if the consumer consents to pay the opportunity cost required to skip the advertisement.

10. The method of claim 1, further comprising receiving, by the electronic brokerage, from the publisher an opportunity receipt callback to be called by the electronic brokerage to provide the publisher with an opportunity receipt confirming receipt of the opportunity attestation, wherein the opportunity receipt callback comprises a universal resource locator (URL).

11. The method of claim 10, further comprising using, by the electronic brokerage, the opportunity receipt callback to asynchronously send the publisher an electronic confirmation of the opportunity attestation.

12. The method of claim 10, wherein the opportunity receipt comprises globally unique identifiers (GUIDs) specific to the opportunity attestation and the consumer, a cost, a channel and a time stamp indicating a time at which the advertising opportunity was attested.

13. The method of claim 10, wherein the opportunity receipt further comprises anonymous demographic information about the consumer.

14. The method of claim 1, further comprising providing, by the electronic brokerage, an electronic mechanism for the consumer via the brokerage account to provide a non-repudiated skip consent or dissent regarding paying to skip the advertisement.

15. The method of claim 14, wherein the electronic skip consent is explicitly authorized by the consumer against the brokerage account and informs the electronic brokerage that the consumer agrees to pay an opportunity cost associated with the skip opportunity to skip the advertisement.

16. The method of claim 15, wherein the one or more conditions comprise:
the brokerage account is credited with a monetary amount greater than or equal to a cost per impression (CPI) specified in the opportunity attestation; and
the brokerage account contains one or more brokerage-backed skip vouchers.

17. The method of claim 14, further comprising when electronic brokerage has received an electronic skip dissent indicating the consumer has explicitly dissented to the skip opportunity, then causing the publisher to present or continue to present the advertisement to the consumer.

18. The method of claim 14, further comprising when the electronic brokerage fails to receive an explicit electronic skip consent or dissent for the skip opportunity within a predetermined time period, then registering, by the electronic brokerage, an implicit skip dissent and causing the publisher to present or continue presenting the advertisement to the consumer.

19. The method of claim 14, further comprising ensuring, by the electronic brokerage, the skip consent/dissent is a secured, non-repudiated agreement by the consumer to pay/not pay the opportunity cost associated with the advertising opportunity and as specified in the opportunity attestation.

20. The method of claim 14, wherein the skip consent/dissent is a non-repudiated electronic communication from the consumer to the electronic brokerage expressing the consumer's intention to skip/not skip the advertising opportunity and comprises information regarding the advertising opportunity and information regarding a fee required to skip the advertising opportunity.

21. The method of claim 14, further comprising providing, by the electronic brokerage, secured electronic mechanisms for consumers to view a ledger detailing all skip consents and dissents they have given, along with data minimally detailing their specific costs, channels and time stamps.

22. The method of claim 1, further comprising charging, by the electronic brokerage, the brokerage account and crediting a brokerage seat of the publisher an opportunity cost in terms of a cost per impression (CPI) set by the publisher that is specific to the skip opportunity only when the electronic brokerage can correlate an explicit electronic receipt of a valid skip consent by the consumer with the opportunity attestation.

23. The method of claim 22, wherein the electronic brokerage does not require a specific order of receipt for opportunity attestations and skip consents/dissents.

24. The method of claim 22, further comprising making, by the electronic brokerage, consumer charges and publisher credits pending for electronic skip consents received but not yet correlated with a corresponding opportunity attestation, which may be due to the corresponding opportunity attestation either not being yet received or processed by the electronic brokerage.

25. The method of claim 22, further comprising ensuring durability, by the electronic brokerage, of the advertising opportunity and reversing the pending charge/credit for an electronic skip consent received for which the electronic brokerage determines no valid electronic opportunity attestation will ever be observed and processed.

26. The method of claim 25, wherein an advertising opportunity's durability is defined by the electronic brokerage as an algorithm to apply during receipt and processing of electronic opportunity attestations and their correlated electronic skip consents/dissents.

27. The method of claim 22, further comprising refusing, by the electronic brokerage, to recognize the opportunity attestation when no correlated electronic skip consent has been received or processed as a pending or permanent charge to the consumer and credit to the publisher.

28. (canceled)

29. The method of claim 22, further comprising validating, by the electronic brokerage, electronically received opportunity attestations and their correlated electronic skip consents/dissents both individually and collectively against criterion that determine whether or not a consumer's brokerage account should be charged and a publisher's brokerage seat credited for skipping associated electronic advertising opportunities.

30. An electronic brokerage system comprising:
a non-transitory storage devices having tangibly embodied therein one or more routines operable to broker a three-party relationship among a consumer, a publisher that provides advertising-supported content via a website and an advertiser representing an advertising opportunity associated with the advertising-supported content;
one or more processors coupled to the non-transitory storage device and operable to execute the one or more routines to perform a method comprising:
responsive to the consumer requesting the advertising-supported content, receiving an opportunity attestation from the publisher, wherein the opportunity attestation indicates to the electronic brokerage that the publisher has offered the consumer an opportunity to skip the advertising opportunity (“skip opportunity”) in exchange for money or credits within a brokerage account of the consumer that is maintained by the electronic brokerage; and
when the electronic brokerage has received an electronic skip consent initiated by the consumer indicating the consumer has explicitly consented to the skip opportunity and the electronic brokerage has affirmatively verified the brokerage account satisfies one or more conditions, then causing the publisher to skip or discontinue presenting an advertisement to the consumer that is associated with the advertising opportunity.

31. The system of claim 30, wherein the opportunity attestation is made electronically by the publisher to the electronic brokerage either immediately prior to the advertising opportunity or in conjunction with a start of the advertising opportunity via a Hypertext Transport Protocol (HTTP) based Application Programming Interface (API) implemented within the electronic brokerage.

32. The system of claim 31, wherein the method further comprises generating and assigning globally unique identifiers (GUIDs) specific to the opportunity attestation and the consumer.

33. The system of claim 31, wherein the opportunity attestation comprises data about an opportunity cost in terms of a cost per impression (CPI) set by the publisher that is specific to the advertising opportunity and required to be paid by the consumer in order to skip the advertisement.

34. The system of claim 31, wherein the opportunity attestation contains additional data including one or more of metadata about the advertisement and metadata about the advertiser.

35. The system of claim 33, wherein the CPI is defined in a currency and denomination specified by the publisher either as part of their brokerage seat with the electronic brokerage or as part of the opportunity attestation.

36. The system of claim 33, wherein the method further comprises leveraging current currency exchange rates to convert the opportunity cost to a currency and denomination appropriate for the consumer according to preferences associated with the brokerage account.

37. The system of claim 34, wherein the method further comprises ensuring the opportunity attestation is a non-repudiated agreement on behalf of the publisher to:
forgo displaying of the advertisement to the consumer in exchange for a payment equivalent to the opportunity cost made by the consumer to the electronic brokerage; and
ensure the advertiser is not charged for the advertising opportunity if the consumer consents to pay the opportunity cost required to skip the advertisement.

38. The system of claim 30, wherein the method further comprises receiving, by the electronic brokerage, from the publisher an opportunity receipt callback to be called by the electronic brokerage to provide the publisher with an opportunity receipt confirming receipt of the opportunity attestation, wherein the opportunity receipt callback comprises a universal resource locator (URL).

39. The system of claim 38, wherein the method further comprises using the opportunity receipt callback to asynchronously send the publisher an electronic confirmation of the opportunity attestation.

40. The system of claim 38, wherein the opportunity receipt comprises globally unique identifiers (GUIDs) specific to the opportunity attestation and the consumer, a cost, a channel and a time stamp indicating a time at which the advertising opportunity was attested.

41. The system of claim 38, wherein the opportunity receipt further comprises anonymous demographic information about the consumer.

42. The system of claim 30, wherein the method further comprises providing an electronic mechanism for the consumer via the brokerage account to provide a non-repudiated skip consent or dissent regarding paying to skip the advertisement.

43. The system of claim 42, wherein the electronic skip consent is explicitly authorized by the consumer against the brokerage account and informs the electronic brokerage that the consumer agrees to pay an opportunity cost associated with the skip opportunity to skip the advertisement.

44. The system of claim 43, wherein the one or more conditions comprise:
the brokerage account is credited with a monetary amount greater than or equal to a cost per impression (CPI) specified in the opportunity attestation; and
the brokerage account contains one or more brokerage-backed skip vouchers.

45. The system of claim 42, wherein the method further comprises when electronic brokerage has received an electronic skip dissent indicating the consumer has explicitly dissented to the skip opportunity, then causing the publisher to present or continue to present the advertisement to the consumer.

46. The system of claim 42, wherein the method further comprises when the electronic brokerage fails to receive an explicit electronic skip consent or dissent for the skip opportunity within a predetermined time period, then registering an implicit skip dissent and causing the publisher to present or continue presenting the advertisement to the consumer.

47. The system of claim 42, wherein the method further comprises ensuring the skip consent/dissent is a secured, non-repudiated agreement by the consumer to pay/not pay the opportunity cost associated with the advertising opportunity and as specified in the opportunity attestation.

48. The system of claim 42, wherein the skip consent/dissent is a non-repudiated electronic communication from the consumer to the electronic brokerage expressing the consumer's intention to skip/not skip the advertising opportunity and comprises information regarding the advertising opportunity and information regarding a fee required to skip the advertising opportunity.

49. The system of claim 42, wherein the method further comprises providing secured electronic mechanisms for consumers to view a ledger detailing all skip consents and dissents they have given, along with data minimally detailing their specific costs, channels and time stamps.

50. The system of claim 30, wherein the method further comprises charging the brokerage account and crediting a brokerage seat of the publisher an opportunity cost in terms of a cost per impression (CPI) set by the publisher that is specific to the skip opportunity only when the electronic brokerage can correlate an explicit electronic receipt of a valid skip consent by the consumer with the opportunity attestation.

51. The system of claim 50, wherein a specific order of receipt for opportunity attestations and skip consents/dissents is not required.

52. The system of claim 50, wherein the method further comprises making consumer charges and publisher credits pending for electronic skip consents received but not yet correlated with a corresponding opportunity attestation, which may be due to the corresponding opportunity attestation either not being yet received or processed by the electronic brokerage.

53. The system of claim 50, wherein the method further comprises ensuring durability of the advertising opportunity and reversing the pending charge/credit for an electronic skip consent received for which the electronic brokerage determines no valid electronic opportunity attestation will ever be observed and processed.

54. The system of claim 53, wherein an advertising opportunity's durability is defined by the electronic brokerage as an algorithm to apply during receipt and processing of electronic opportunity attestations and their correlated electronic skip consents/dissents.

55. The system of claim 50, wherein the method further comprises refusing to recognize the opportunity attestation when no correlated electronic skip consent has been received or processed as a pending or permanent charge to the consumer and credit to the publisher.

56. The system of claim 50, wherein the method further comprises validating electronically received opportunity attestations and their correlated electronic skip consents/dissents both individually and collectively against criterion that determine whether or not a consumer's brokerage account should be charged and a publisher's brokerage seat credited for skipping associated electronic advertising opportunities.
